(19) United States
(12) Patent Application Publication
(10) Pub. No.: US 2025/0327344 A1
(43) Pub. Date: Oct. 23, 2025

(54) CONTROLLER AND CONTROL METHOD

(71) Applicant: FUJI ELECTRIC CO., LTD., Kanagawa (JP)

(72) Inventor: Shinji YUKAWA, Mie (JP)

(21) Appl. No.: 19/065,301

(22) Filed: Feb. 27, 2025

(30) Foreign Application Priority Data
Apr. 18, 2024 (JP) 2024-067443

(51) Int. Cl. E05B 81/56; E05B 77/36; E05B 81/08; E05B 83/02

(52) U.S. Cl. CPC E05B 81/56; E05B 77/36; E05B 81/08; E05B 83/02

(57) ABSTRACT

In a controller for controlling an operation of a locking device, the locking device includes a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door, and the controller is configured to control the second force generator to reduce the second force during the unlocking of the door.

The present application is based on and claims priority to Japanese patent application no. 2024-067443 filed on Apr. 18, 2024, with the Japanese Patent Office, the entire contents of which are hereby incorporated by reference.

### BACKGROUND OF THE INVENTION

### 1. Field of the Invention

The disclosures herein relate to controllers and control methods.

### 2. Description of the Related Art

Conventionally, a technology for reducing noise generated during locking or unlocking of a door of a railway vehicle is known (see, e.g., Patent Literature (PTL) 1).

However, according 1, noise to PTL reduction is achieved by using a cushioning material to absorb an impact caused by a collision between parts during unlocking of a door. Therefore, although some effectiveness can be expected, the impact caused by contact between parts cannot be entirely prevented, and thus the effect is limited.

Therefore, in view of the above problems, it is an object to provide a technology capable of reducing noise during locking or unlocking a door of a railway vehicle.

### CITATION LIST

### Patent Literature

[PTL 1] Japanese Laid-Open Patent Publication No. 2021-142880

### SUMMARY OF THE INVENTION

In order to achieve an above-mentioned object, in one embodiment of the present disclosure, a controller for controlling an operation of a locking device, wherein the locking device includes a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door, and wherein the controller is configured to control the second force generator to reduce the second force during the unlocking of the door, is provided.

In another embodiment of the present disclosure, a controller for controlling an operation of a locking device, wherein the locking device includes a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door, and wherein the controller is configured to control the second force generator to generate the second force to reduce an effect of the first force generator on the second member, is provided.

In further another embodiment of the present disclosure, a control method for controlling an operation of a locking device, the locking device including a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door, wherein the control method includes controlling the second force generator to reduce the second force during the unlocking of the door, is provided.

In further another embodiment of the present disclosure, a control method for controlling an operation of a locking device, the locking device including a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door, wherein the control method includes controlling the second force generator to generate the second force to reduce an effect of the first force generator on the second member during the unlocking of the door, is provided.

According to the above embodiments, noise during locking or unlocking a door of a railway vehicle can be reduced.

### BRIEF DESCRIPTION OF THE DRAWINGS

FIG. 1 is a block diagram illustrating an example of a structure for controlling a door of a railway vehicle;

FIG. 2 is a drawing illustrating an example of a door locking device;

FIG. 3 is a drawing illustrating an example of the door locking device;

FIG. 4 is a drawing illustrating an example of a driving circuit of the locking device;

FIG. 5 is a drawing describing a comparative example of a control method for the locking device during the unlocking of the door;

FIG. 6 is a drawing illustrating a specific example of a control result according to the comparative example of the control method for the locking device during the unlocking of the door;

FIG. 7 is a drawing illustrating a first example of a control method for the locking device during the unlocking of the door by a door controller according to the embodiment;

FIG. 8 is a drawing illustrating a specific example of a control result according to the first example of the control method for the locking device during the unlocking of the door;

FIG. 9 is a drawing describing a second example of the control method for the locking device during the unlocking of the door by the door controller according to the embodiment;

FIG. 10 is a drawing illustrating a specific example of a control result according to the second example of the control method for the locking device during the unlocking of the door;

FIG. 11 is a drawing describing a third example of the control method for the locking device during the unlocking of the door by the door controller according to the embodiment;

FIG. 12A is a drawing illustrating an operation of the locking device corresponding to the third example of the control method for the locking device during the unlocking of the door at a time t1;

FIG. 12B is a drawing illustrating the operation of the locking device corresponding to the third example of the control method for the locking device during the unlocking of the door at a time t2;

FIG. 12C is a drawing illustrating the operation of the locking device corresponding to the third example of the control method for the locking device during the unlocking of the door at a time t3;

FIG. 13A is a drawing illustrating an operation of the locking device corresponding to the third example of the control method for the locking device during the unlocking of the door at a time t4;

FIG. 13B is a drawing illustrating the operation of the locking device corresponding to the third example of the control method for the locking device during the unlocking of the door at a time t5;

FIG. 13C is a drawing illustrating the operation of the locking device corresponding to the third example of the control method for the locking device during the unlocking of the door at a time t6;

FIG. 14A is a drawing describing a comparative example of an operation of the locking device during locking the door at a time t41;

FIG. 14B is a drawing describing the comparative example of the operation of the locking device during locking the door at a time t42;

FIG. 14C is a drawing describing the comparative example of the operation of the locking device during locking the door at a time t43;

FIG. 15 is a drawing describing the comparative example of the operation of the locking device during locking the door;

FIG. 16 is a drawing describing an example of the control method for the locking device during locking the door by the door controller according to the embodiment;

FIG. 17A is a drawing illustrating an operation of the locking device at a time t51;

FIG. 17B is a drawing illustrating the operation of the locking device at a time t52;

FIG. 17C is a drawing illustrating the operation of the locking device at a time t53;

FIG. 17D is a drawing illustrating the operation of the locking device at a time t54;

FIG. 18A is a drawing illustrating the operation of the locking device at a time t55;

FIG. 18B is a drawing illustrating the operation of the locking device at a time t56; and

FIG. 18C is a drawing illustrating an operation of the locking device at a time t57.

### DESCRIPTION OF THE PREFERRED EMBODIMENTS

In the following, embodiments of the present invention will be described with reference to the accompanying drawings.

### Configuration for Control of a Door of a Railway Vehicle

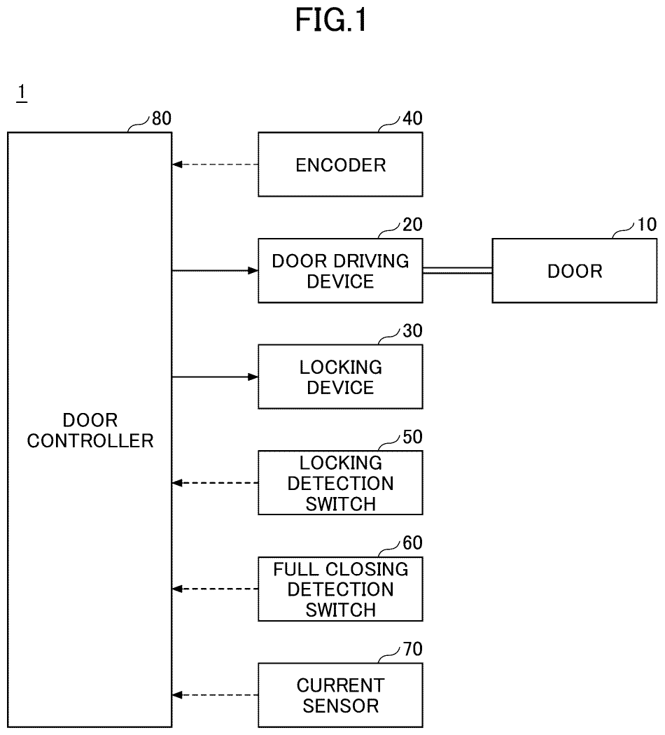

Referring to FIG. 1, a configuration related to control of a door 10 of a railway vehicle 1 according to the present embodiment will be described.

FIG. 1 is a block diagram illustrating an example of a structure for controlling the door 10 of a railway vehicle 1.

As shown in FIG. 1, the railway vehicle 1 includes the door 10, a door driving device 20, a locking device 30, an encoder 40, a locking detection switch 50, a full closing detection switch 60, a current sensor 70, and a door controller 80.

The railway vehicle 1 may be a one-car train having one vehicle, or a multi-car train having a plurality of vehicles connected in a row.

The door 10 is provided at an opening (hereinafter, for convenience, referred to as “door opening”) on a side of a body of the railway vehicle 1. The door 10 is, for example, a double sliding door.

The door driving device 20 mechanically drives the door 10 in opening and closing directions. The door driving device 20 is installed above the interior of the door opening in the body of the railway vehicle 1. The door driving device 20 includes, for example, an electric motor, and drives the door 10 in the opening and closing directions using the electric motor as a power source. The electric motor may be a rotary motor or a linear motor. In the present embodiment, description will be given mainly on a case of a linear motor.

The door driving device 20 operates controlled by the door controller 80. For example, the door driving device 20 is electrically driven by electric power supplied from the door controller 80.

The locking device 30 locks and unlocks the door 10. The locking device 30, like the door driving device 20, is provided above the interior side of the door opening of the body of the railway vehicle 1.

The locking device 30 operates controlled by the door controller 80. For example, it is electrically driven by power supplied from the door controller 80.

The encoder 40 outputs detection information related to a position of the door 10. For example, the encoder 40 detects a rotational position and rotational speed of the rotary motor included in the door driving device 20 and a displacement position of a mover of the linear motor, and outputs the detection information. The detection information of the encoder 40 is received into the door controller 80.

The locking detection switch 50 is a momentary switch for detecting a locked state of the door 10 by the locking device 30. When the door 10 is locked by the locking device 30, the locking detection switch 50 is turned on by mechanically pressing an actuator by a predetermined member of the locking device 30. Conversely, when the door 10 is not locked by the locking device 30, that is, in an unlocked state, the locking detection switch 50 is turned off because the actuator is not pressed by the member. A detection signal (i. e., on signal or off signal) indicating the on/off state of the locking detection switch 50 is received in the door controller 80. Thus, when the detection signal of the locking detection switch 50 is an on signal, the door 10 is locked by the locking device 30, and when the detection signal of the locking detection switch 50 is an off signal, the door controller 80 can determine that the door 10 is unlocked.

The full closing detection switch 60 is a momentary switch for detecting a fully closed state of the door 10. When the door 10 is fully closed, the full closing detection switch 60 is in the on state, with the actuator being mechanically pressed by a member that is interlocked with the door 10. Conversely, when the door 10 is not fully closed, the full closing detection switch 60 is in the off state by releasing pressing of the actuator by the member.

The detection signal (i.e., on signal or off signal) indicating the on/off state of the full closing detection switch 60 is received in the door controller 80. Thus, the door controller 80 can determine that the door 10 is in the fully closed state when the detection signal of the full closing detection switch 60 is the on signal, and that the door 10 is not in the fully closed state when the detection signal of the full closing detection switch 60 is the off signal.

The current sensor 70 detects a current of the locking device 30, specifically, a current of a coil 34C of a solenoid 34 described later. The detection signal of the current sensor 70 is received in the door controller 80.

The door controller 80 controls the operation of the door 10.

Specifically, the door controller 80 controls the operation of the door 10 by electrically driving the door driving device 20 along a sequence of the opening or closing operation of the door 10. For example, the door controller 80 has a power converter that converts a DC supplied from a predetermined power source of the railway vehicle 1 into a three-phase AC of a predetermined voltage and a predetermined frequency, and controls the power converter to supply driving power to the door driving device 20. The power converter may be located outside the door controller 80.

In addition, the door controller 80 performs switching control of unlocking and locking of the door 10 by electrically driving the locking device 30 along the sequence of opening or closing of the door 10.

### Configuration of Locking Device

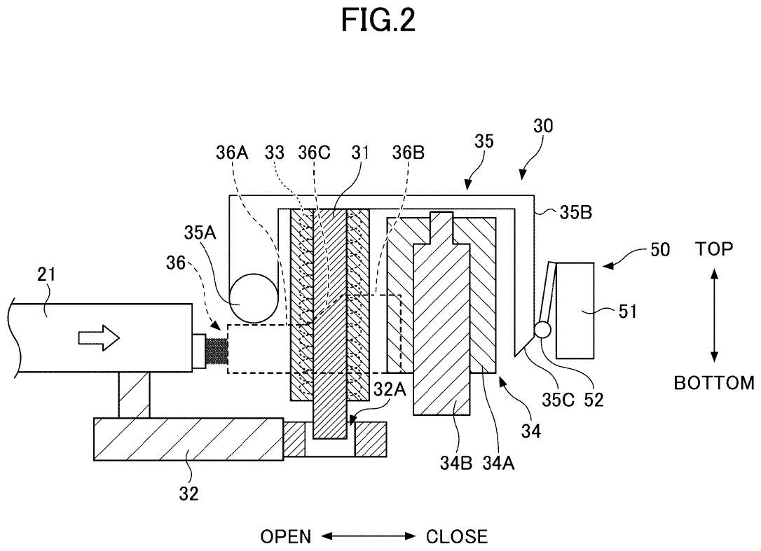

Next, the configuration of the locking device 30 according to the present embodiment will be described with reference to FIGS. 2 to 4.

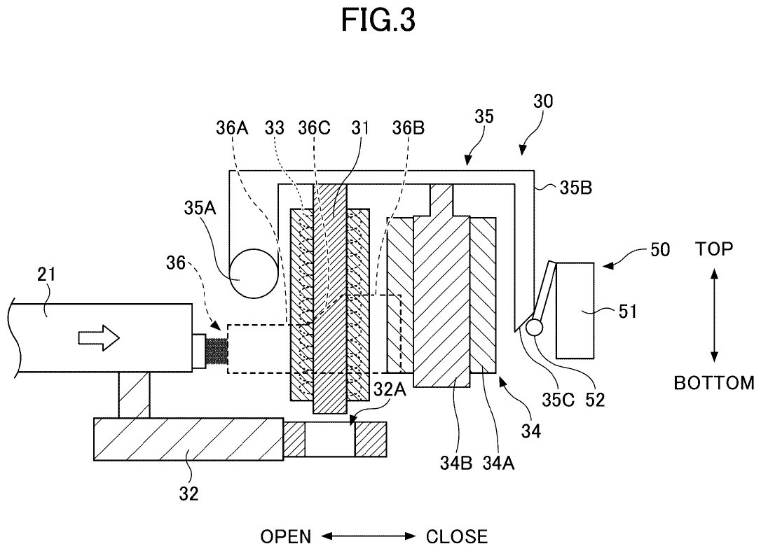

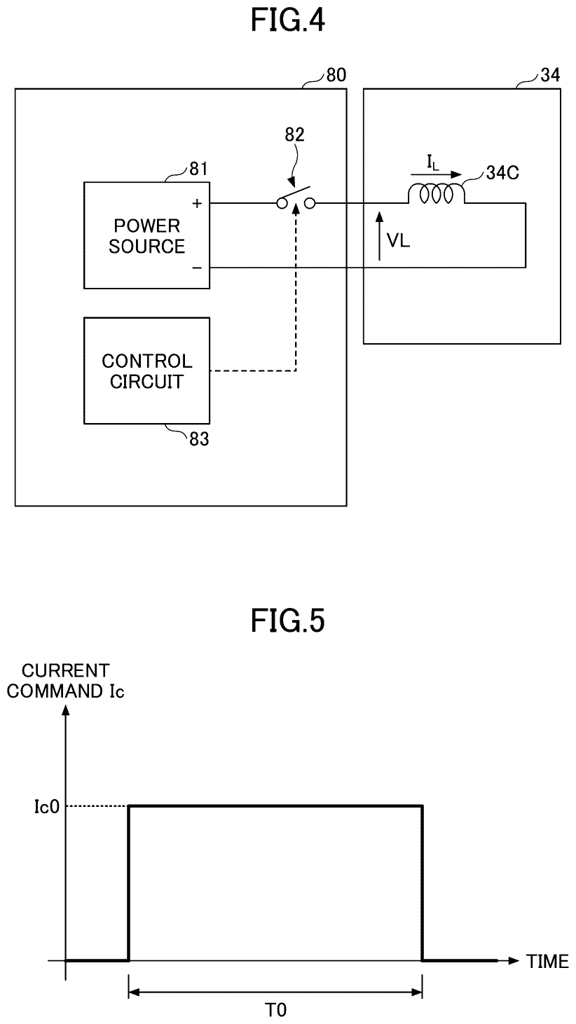

FIGS. 2 and 3 are drawings illustrating an example of the locking device 30 of the door 10. Specifically, FIG. 2 shows an example of the locking device 30 when the door 10 is in the fully closed position and the door 10 is locked by the locking device 30. FIG. 3 shows an example of the locking device 30 when the door 10 is in the fully closed state and the door 10 is unlocked by the locking device 30. FIG. 4 shows an example of the driving circuit of the locking device 30.

In FIGS. 2 and 3, the door 10 arranged below the locking device 30 is not shown. In FIGS. 2 and 3, the left direction represents the opening direction of the door 10, and the right direction represents the closing direction of the door 10.

As shown in FIGS. 2 and 3, in the present example, the locking device 30 includes a lock pin 31, an opening and closing interlocking member 32, a biasing spring 33, a solenoid 34, a vertical slider 35, and a horizontal slider 36.

The lock pin 31 is supported so as to be movable in the vertical a direction within predetermined range.

The opening and closing interlocking member 32 is directly or indirectly connected to the door 10, and moves in the opening or closing direction interlocking with the opening or closing operation of the door 10. In this example, the opening and closing interlocking member 32 is connected to the mover 21 of the linear motor included in the door driving device 20, and interlocks with the movement of the mover 21 in the opening or closing direction. The opening and closing interlocking member 32 is arranged below the lock pin 31 in the vertical direction and has a lock hole 32A.

The lock hole 32A is a recess provided on an upper surface of the opening and closing interlocking member 32 and is arranged so that the lock pin 31 can be inserted from above in the fully closed position of the door 10. The lock pin 31 is arranged so that its lower end is respectively above and below the opening of the lock hole 32A at the upper and lower stroke ends of the vertical movable range of the lock pin 31. Thus, when the door 10 is in the fully closed position, the lock pin 31 is inserted into the lock hole 32A from above to regulate the opening and closing operation of the door 10 and lock the door 10. The lock hole 32A may penetrate the opening and closing interlocking member 32 vertically, for example, as shown in FIGS. 2 and 3, or it may only be opened upward and not penetrate downward. The lock hole 32A may be a recess for regulating the opening and closing operation of the door 10 as shown in FIGS. 2 and 3, or it may be a structure for regulating the movement of the door 10 only in the opening direction.

The biasing spring 33 is arranged so as to bias the lock pin 31 downward when the lock pin 31 is at least above the lower stroke end in a vertically movable range. Thus, the biasing spring 33 can bias the lock pin 31 to be inserted into the lock hole 32A when the door 10 is in the fully closed position. Therefore, the locking device 30 can lock the door 10 by the biasing force of the biasing spring 33.

The solenoid 34 is an actuator that moves the lock pin 31 upward through the vertical slider 35. The solenoid 34 includes a housing 34A, a plunger 34B and a coil 34C housed in the housing 34A.

In the solenoid 34, when no current flows through the coil 34C, the upper end of the plunger 34B is housed in the housing 34A. In the solenoid 34, when a current flows through the coil 34C, the plunger 34B is attracted by a fixed iron core magnetized by the coil 34C, and the upper end of the plunger 34B projects upward from the housing 34A.

For example, as shown in FIG. 4, the door controller 80 includes a power source 81, a switch 82 provided in a closed circuit for applying a voltage VL to the coil 34C by the power source 81, and a control circuit 83 for opening and closing the switch 82. When the switch 82 is in an open state, the voltage VL by the power source 81 is not applied to the coil 34C, and the current IL does not flow. Conversely, when the switch 82 is in the closed state, the voltage VL is applied to the coil 34C and the current IL flows, whereby the fixed iron core is magnetized, and as a result, the plunger 34B is attracted by the fixed iron core, so that the upper end of the plunger 34B projects upward from the housing. For example, the control circuit 83 can control the current of the coil 34C by turning on and off the switch 82 with a PWM (Pulse Width Modulation) signal in response to the current command Ic.

The vertical slider 35 is arranged so as to cover the upper parts of the lock pin 31 and the solenoid 34, and can be moved in the vertical direction. The vertical slider 35 is directly on indirectly connected to the lock pin 31 through another member, and its lower surface is in contact with the solenoid 34. As a result, the plunger 34B of the solenoid 34 projects upward from the housing 34A, thereby moving the vertical slider 35 upward, and consequently moving the lock pin 31 upward. Therefore, the solenoid 34 disengages the lock pin 31 from the lock hole 32A in the fully closed position of the door 10, and can shift the door 10 from the locked state to the unlocked state.

The horizontal slider 36 can move in the opening and closing directions of the door 10 interlocking with the opening and closing operation of the door 10. In this example, the horizontal slider 36 moves in the opening and closing directions of the door 10 interlocking with the operation of the mover 21. The horizontal slider 36 abuts against an abutting part 35A of the vertical slider 35 to support the vertical slider 35 from below. The horizontal slider 36 includes supporting surfaces 36A to 36C.

The supporting surface 36A is located below the abutting part 35A of the vertical slider 35 when the horizontal slider 36 is at a position corresponding to the fully closed state of the door 10. The supporting surface 36A is arranged so that it can abut against the abutting part 35A of the vertical slider 35 when the lock pin 31 is inserted into the lock hole 32A.

The supporting surface 36B is located below the abutting part 35A of the vertical slider 35 when the horizontal slider 36 is moved to some extent in the opening direction of the door 10 with reference to the position corresponding to the fully closed state of the door 10. The supporting surface 36B is located above the supporting surface 36A in the vertical direction and is arranged so that it can abut against the abutting part 35A of the vertical slider 35 when the plunger 34B of the solenoid 34 projects upward from the housing by a maximum amount.

The supporting surface 36C is formed as a slope connecting the supporting surface 36A and the supporting surface 36B in the opening and closing directions of the door 10.

At a start of the opening operation of the door 10, the door 10 shifts from the locked state to the unlocked state by the locking device 30, so that the plunger 34B projects from the housing 34A. Therefore, in a state where the abutting part 35A of the vertical slider 35 is above the supporting surface 36A of the horizontal slider 36, specifically at a same height as the supporting surface 36B, the horizontal slider 36 starts moving in the opening direction of the door 10 interlocking with the opening operation of the door 10. When the door 10 moves to some extent from the fully closed state to the opening direction, the supporting surface 36B of the horizontal slider 36 is positioned below the abutting part 35A of the vertical slider 35. Therefore, even when energization of the coil 34C of the solenoid 34 is completed and the state where the upper end of the plunger 34B projects from the housing 34A is released, the abutting part 35A of the vertical slider 35 is supported by the supporting surface 36B, and the vertical position of the 41 vertical slider 35 is maintained.

Additionally, in the closing operation of the door 10, as the door 10 moves from the fully open position to the fully closed position, the position of the horizontal slider 36 where the abutting part 35A of the vertical slider 35 can abut changes in an order of the supporting surface 36B, the supporting surface 36C, and the supporting surface 36A.

Therefore, when the lock hole 32A reaches directly below the lock pin 31 in accordance with the closing operation of the door 10, the lock pin 31 is automatically inserted into the lock hole 32A by the biasing force of the biasing spring 33 and a self-weight of the lock pin 31, and the door 10 can be locked.

For example, the locking detection switch 50 is disposed adjacent to a lateral surface 35B of the vertical slider 35. The locking detection switch 50 includes a body part 51 and an actuator 52.

The locking detection switch 50 is a momentary switch, and a biasing force acts on the actuator 52 so as to maintain the state that the actuator 52 is separated from the body part 51, that is, the off state.

As shown in FIG. 2, when the lock pin 31 is inserted into the lock hole 32A and the door 10 is locked, a tip of the actuator 52 abuts against the lateral surface 35B of the vertical slider 35 and is pressed against the body part 51. As a result, the locking detection switch 50 is turned on in accordance with the locked state of the door 10.

Conversely, as shown in FIG. 3, when the lock pin 31 is not inserted into the lock hole 32A and the door 10 is unlocked, the tip of the actuator 52 and the lateral surface 35B of the vertical slider 35 are not adjacent to each other in the opening/closing direction of the door 10. Therefore, the state in which the tip of the actuator 52 abuts against the lateral surface 35B of the vertical slider 35 is released, and as a result, the locking detection switch 50 is turned off in accordance with the unlocked state of the door 10.

The lower end surface 35C adjacent to the lower end of the lateral surface 35B of the vertical slider 35 is inclined downward in the direction away from the locking detection switch 50. Therefore, when the door 10 is unlocked by the locking device 30, the tip of the actuator 52 of the locking detection switch 50 is released from the state of abutting on the lateral surface 35B, and then continues to abut on the lower end surface 35C of the vertical slider 35. As a result, the locking detection switch 50 switches from on to off while the tip of the actuator 52 abuts on the lower end surface 35C of the vertical slider 35 according to a rise of the vertical slider 35. When the door 10 is locked by the locking device 30, the tip of the actuator 52 of the locking detection switch 50 abuts on the lower end surface 35C of the vertical slider 35 according to a fall of the vertical slider 35 after an insertion of the lock pin 31 into the lock hole 32A. Then, the tip of the actuator 52 of the locking detection switch 50 approaches the lateral surface 35B while abutting on the lower end surface 35C of the vertical slider 35 according to the fall of the vertical slider 35, and shifts to the state of abutting on the lateral surface 35B. As a result, the locking detection switch 50 switches from off to on while abutting on the lower end surface 35C of the vertical slider 35 according to the fall of the vertical slider 35.

### Comparative Example of Control Methods of Locking Device During Unlocking Device

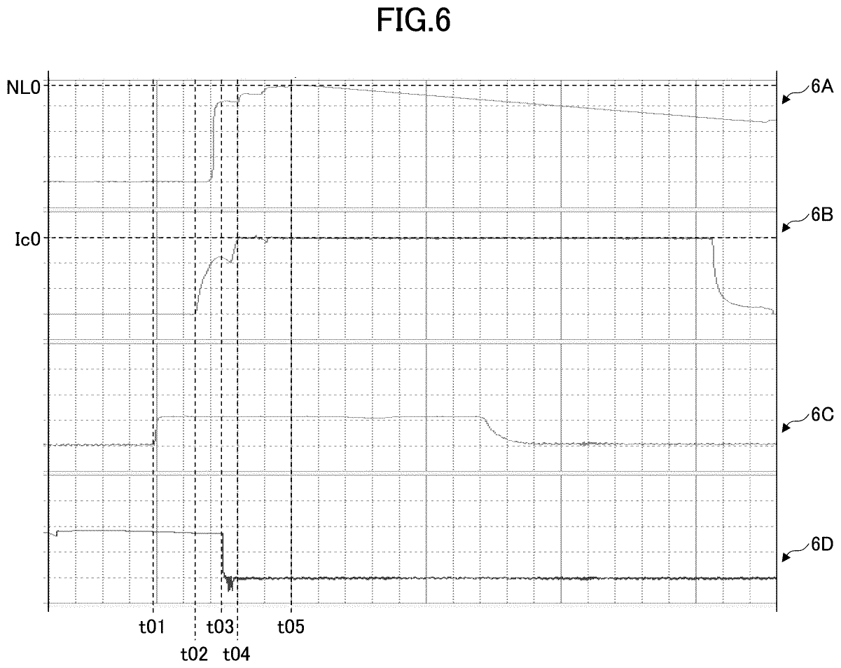

Next, a comparative example of control methods of the locking device 30 during the unlocking of the door 10 will be described with reference to FIGS. 5 and 6.

Hereinafter, in the comparative example, a subject of the control method for the locking device 30 during the unlocking of the door 10 will be described as a “door controller” without reference numeral for convenience.

FIG. 5 is a drawing describing the comparative example of the control method for the locking device 30 during unlocking the door 10. FIG. 6 is a drawing illustrating a specific example of a control result according to the comparative example of the control method for the locking device 30 during the unlocking of the door 10.

Specifically, FIG. 5 is a time chart showing the comparative example of the current command Ic of the coil 34C of the solenoid 34 at the time of unlocking the door 10. FIG. 6 is a time chart showing the control result according to the comparative example of the control method for the locking device 30 at the time of unlocking the door 10, and includes Sections 6A to 6D. Section 6A shows a time chart of a noise amount, Section 6B shows a time chart of a current (actual value) of the coil 34C, Section 6C shows a time chart of an unlocking command signal, and Section 6D shows a time chart of a detection signal (locking detection signal) of the locking detection switch 50.

As shown in FIG. 5, in the comparative example, the current command Ic of the coil 34C steps up from zero to a predetermined value Ic0 in response to a transition of the unlocking command signal of the door 10 from off to on. The current command Ic maintains the state of the predetermined value Ic0 for a predetermined duration T0, and then steps down from the predetermined value Ic0 to zero. The duration T0 is set in advance so as to be sufficiently longer than a minimum time required to complete the unlocking operation by the locking device 30, that is, to complete the movement of the lock pin 31 from the lower end position to the upper end position, starting from the transition of the current command Ic from zero.

When the unlocking command signal (specifically, the on signal) of the door 10 is output, the door controller controls the current of the coil 34C in accordance with the current command Ic shown in FIG. 5. As in the case of the control circuit 83 of the door controller 80, for example, the current of the coil 34C can be controlled by turning on and off the switch 82 by the PWM signal.

As shown in Section 6C in FIG. 6, at a time t01, the unlocking command signal of the door 10 is output, and the unlocking command signal transitions from off (i.e., low level) to on (i.e., high level). As a result, as shown in FIG. 5, the current command Ic steps up in response to the output of the unlocking command signal of the door 10.

As shown in Section 6B in FIG. 6, as the current command Ic steps up, the current (actual value) of the coil 34C starts transition at a relatively steep slope from zero at a time t02.

Then, as shown in Sections 6B and 6D in FIG. 6, at time t03, the locking detection signal transitions from on (high level) to off (low level) as the vertical slider 35 moves upward in response to extension of the plunger 34B.

Then, as shown in Section 6B in FIG. 6, at a time t04, the current of the coil 34C reaches the predetermined value Ic0, and thereafter, this state is maintained in response to the current command Ic.

In the comparative example, the current of the coil 34C transitions upward at a relatively large slope, and after reaching a relatively large current value (predetermined value Ic0), the state is maintained. Therefore, a thrust of the plunger 34B becomes relatively large immediately after the upward movement starts, and the state is maintained. As a result, the noise caused by the impact when the plunger 34B starts moving, the noise caused by the impact when the plunger 34B comes into contact with the vertical slider 35, and the noise caused by the impact when the plunger 34B reaches the stroke end are extremely large. Therefore, as shown in SECTION 6A, the noise amount rapidly increases after the upward transition of the current of the coil 34C, and shows an extremely large maximum value NL0 at a time t05 after a time t04.

Thus, in the comparative example, since the thrust of the plunger 34B during the unlocking of the door 10 is relatively large as a whole, there is a possibility that an extremely large noise is generated due to the impact caused by the operation of the plunger 34B itself or the impact caused by the contact between the plunger 34B and other members.

### First Example of Control Method of Locking Device During Unlocking of Door

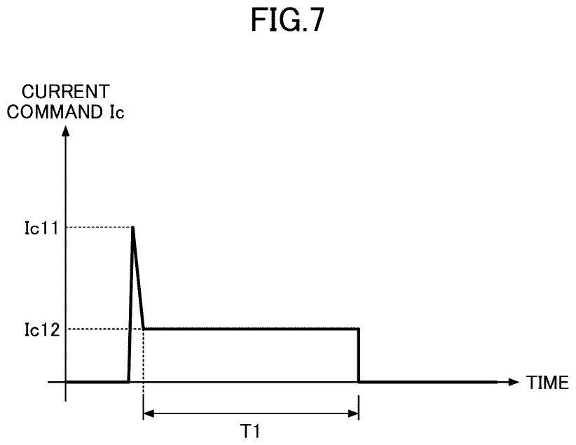

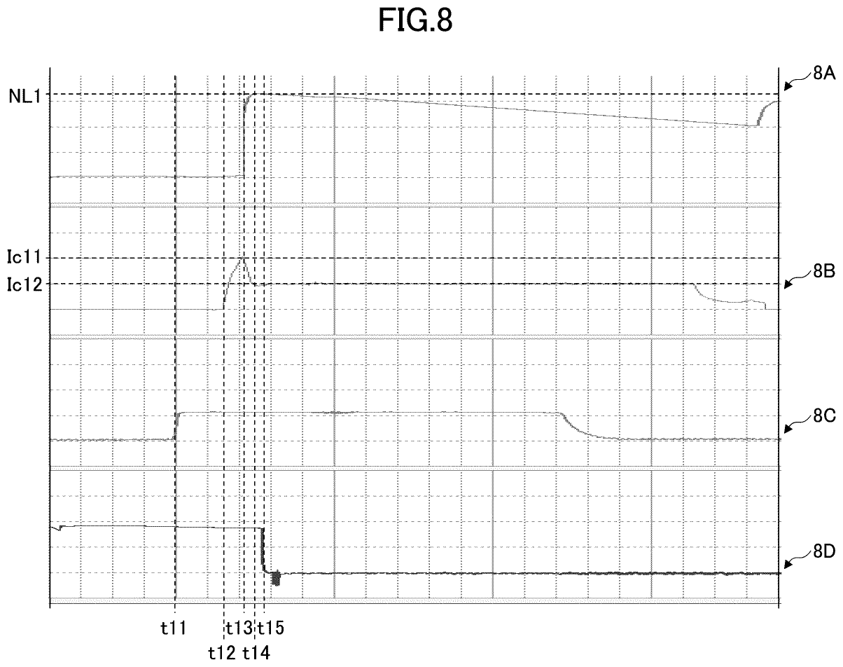

Next, a first example of control method for the locking device 30 during the unlocking of the door 10 will be described with reference to FIGS. 7 and 8.

FIG. 7 is a drawing illustrating the first example of the control method for the locking device 30 during the unlocking of the door 10 according to the embodiment. FIG. 8 is a drawing illustrating a specific example of a control result according to the first example of the control method for the locking device 30 during the unlocking of the door 10.

Specifically, FIG. 7 is a time chart showing the first example of the current command Ic of the coil 34C of the solenoid 34 at the time of unlocking the door 10. FIG. 8 is a time chart showing the control result of the first example of control method for the locking device 30 at the time of unlocking the door 10, and includes Sections 8A to 8D. Section 8A shows a time chart of the noise amount, Section 8B in FIG. 8 shows a time chart of the current (actual value) of the coil 34C, Section 8C shows a time chart of the unlocking command signal, and Section 8D shows a time chart of the detection signal (locking detection signal) of the locking detection switch 50.

As shown in FIG. 7, in this example, the current command Ic of the coil 34C transitions from zero to a predetermined value Ic11 at a relatively slope in accordance with the steep and constant transition from off to on of the unlocking command signal of the door 10. When the current command Ic reaches the predetermined value Ic11, it transitions downward from the predetermined value Ic11 to a predetermined value Ic12 (<Ic11) at a relatively steep and constant slope. When the current command Ic reaches the predetermined value Ic12, it maintains the state of the predetermined value Ic12 for a predetermined duration T1, and then steps down from the predetermined value Ic12 to zero.

The duration T1 is set in advance so as to be sufficiently longer than the minimum time required to complete the unlocking operation by the locking device 30, for example, starting from the transition from zero of the current command Ic.

When the unlocking command signal (specifically, the on signal) of the door 10 is output, the door controller 80 controls the current of the coil 34C in accordance with the current command Ic shown in FIG. 7. The door controller 80 feedback-regulates the current of the coil 34C based on the current command Ic and an actual current measurement value Id based on the detection signal of the current sensor 70. Further, the door controller 80 may perform open-loop control of the current of the coil 34C based on the current command Ic without using the detection signal of the current sensor 70. The second and third examples of the control method described below may also be the same.

As shown in Section 8C in FIG. 8, at a time t11, the unlocking command signal of the door 10 is output, and the unlocking command signal rises from off to on. As a result, as shown in FIG. 7, the current command Ic transitions upward with a relatively large slope according to the output of the unlocking command signal.

As shown in Section 8B in FIG. 8, at a time t12, the current (actual value) of the coil 34C starts upward transition with a relatively steep slope from zero in response to the transition of the current command Ic with a relatively steep slope. Then, at a time t13, when the current of the coil 34C reaches the predetermined value Ic11, it starts downward transition with a relatively steep slope according to the current command Ic. Then, at time t14, the current of the coil 34C reaches the predetermined value Ic12, and thereafter, this state is maintained in response to the current command.

After a time t14, as shown in Section 8D in FIG. 8, at a time t15, the locking detection signal transitions downward from on to off in accordance with the upward movement of the vertical slider 35 in response to the extension of the plunger 34B.

In this example, after the current of the coil 34C rises to the predetermined value Ic11 at a relatively steep slope, it transitions downward to the predetermined value Ic12 before the locking detection signal shifts to off, and the state is maintained. Thus, while preventing the extension of the time required for the transition of the door 10 from the locked state to the unlocked state by the locking device 30, the door controller 80 can reduce the thrust when the plunger 34B reaches the stroke end compared with the case of the comparative example. Therefore, although the noise caused by the impact when the plunger 34B starts moving and the noise caused by the impact when the plunger 34B comes in contact with the vertical slider 35 become relatively large, the noise caused by the impact when the plunger 34B reaches the stroke end is prevented. As a result, as shown in Section 8A in FIG. 8, the noise amount rapidly increases after an upward transition of the current of the coil 34C and shows the maximum value NL1 (<NL0), but then decreases. Therefore, the door controller 80 can reduce the noise compared with the case of the comparative example.

### Second Example of Control Method for Locking Device During Unlocking of Door

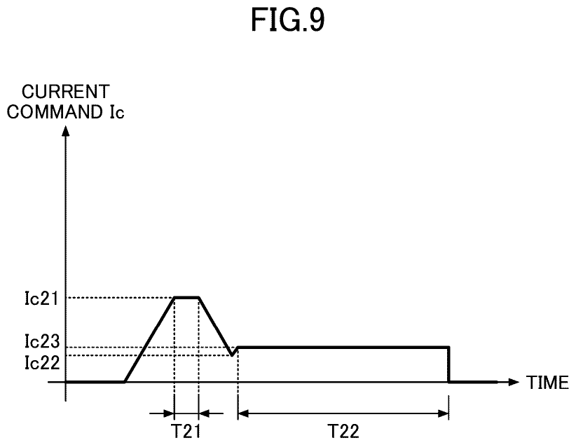

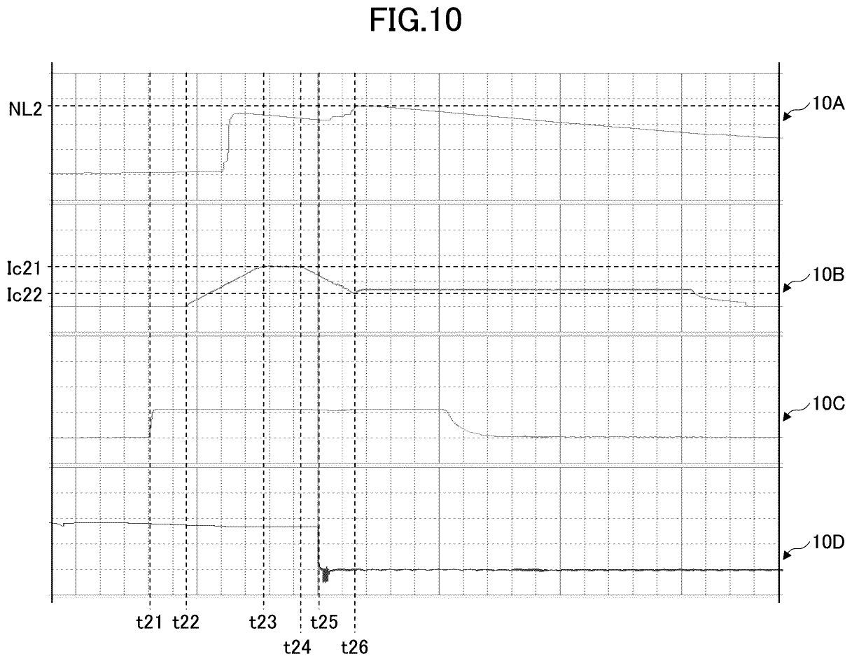

Next, a second example of control method for the locking device 30 during the unlocking of the door 10 will be described with reference to FIGS. 9 and 10.

FIG. 9 is a drawing describing the second example of the control method for the locking device 30 during the unlocking of the door 10 by the door controller 80 according to the embodiment. FIG. 10 is a drawing illustrating a specific example of a control result according to the second example of the control method for the locking device 30 during the unlocking of the door 10.

Specifically, FIG. 9 is a time chart showing the second example of the time change of the current command Ic of the coil 34C of the solenoid 34 when the door 10 is unlocked. FIG. 10 is a time chart of the control result of the second example of the method of controlling the locking device 30 when the door 10 is unlocked, and includes Section 10A to 10D. Section 10A shows a time chart of the noise amount, Section 10B shows a time chart of the current (actual value) of the coil 34C, Section 10C shows a time chart of the unlocking command signal, and Section 10D shows a time chart of the detection signal (locking detection signal) of the locking detection switch 50.

As shown in FIG. 9, in this example, the current command Ic of the coil 34C transitions from zero to a predetermined value Ic21 with a relatively gentle constant slope in accordance with a transition from off to on of the unlocking command signal of the door 10. When the current command Ic reaches the predetermined value Ic21, it maintains the predetermined value Ic21 for a predetermined duration T21, and then transitions downward from the predetermined value Ic21 to a predetermined value Ic22 (<Ic21) with a relatively gentle constant slope. When the current command Ic reaches the predetermined value Ic22, the current command Ic transitions upward from the predetermined value Ic22 to a predetermined value Ic23 (Ic22<Ic23<Ic21) with a relatively gentle constant slope. When the current command Ic reaches the predetermined value Ic23, the current command Ic maintains the state of the predetermined value Ic23 for a predetermined duration T22, and then steps down from the predetermined value Ic23 to zero.

The duration T22 is set in advance so as to be sufficiently longer than the minimum duration required to complete the unlocking operation by the locking device 30, for example, starting from the transition of the current command Ic from zero.

As shown in Section 10C in FIG. 10, at a time t21, the unlocking command signal of the door 10 is output, and the unlocking command signal transitions from off to on. As a result, as shown in FIG. 9, the current command Ic transitions upward with a relatively large slope in response to the output of the unlocking command signal.

As shown in Section 10B in FIG. 10, the current (actual value) of the coil 34C transitions upward with a relatively steep slope from zero at time t22 in response to the upward transition of the current command Ic with a relatively gentle constant slope. Thereafter, at time t23, the current of the coil 34C reaches the predetermined value Ic21, is maintained at the predetermined value Ic2, and starts downward transition with a relatively gentle slope in response to the current command Ic at time t24.

Then, as shown in Section 10D in FIG. 10, at a time t25 when the current of the coil 34C is transitioning upward from the predetermined value Ic21 to the predetermined value Ic22, the locking detection signal transitions from on to off with the upward movement of the vertical slider 35 in response to the extension of the plunger 34B.

Then, as shown in Section 10B in FIG. 10, the current of the coil 34C reaches the predetermined value Ic22 and starts upward transition relatively slowly in response to the current command Ic.

In this example, the current of the coil 34C transitions upward to the predetermined value Ic21 with a relatively slow slope, and then starts downward transition from the predetermined value Ic21 to the predetermined value Ic22 before the locking detection signal shifts to off. Thus, the door controller 80 can reduce the thrust immediately after the start of the movement of the plunger 34B and the thrust at the time of reaching the stroke end, as compared with the case of the comparative example, while preventing the extension of the time required for the transition of the door 10 from the locked state to the unlocked state by the locking device 30. Therefore, the noise caused by the impact of the start of the movement of the plunger 34B, the noise caused by the impact of the plunger 34B coming into contact with the vertical slider 35, and the noise caused by the impact of the plunger 34B reaching the stroke end are reduced. As a result, as shown in Section 10B in FIG. 10, the maximum value NL2 due to a sudden increase after the upward transition of the current of the coil 34C and the maximum value NL2 (<NL0) due to the subsequent arrival of the plunger 34B at the stroke end are reduced. Therefore, the door controller 80 can further reduce the noise compared with the case of the comparative example.

### Third Example of Control Method for Locking Device During Unlocking of Door

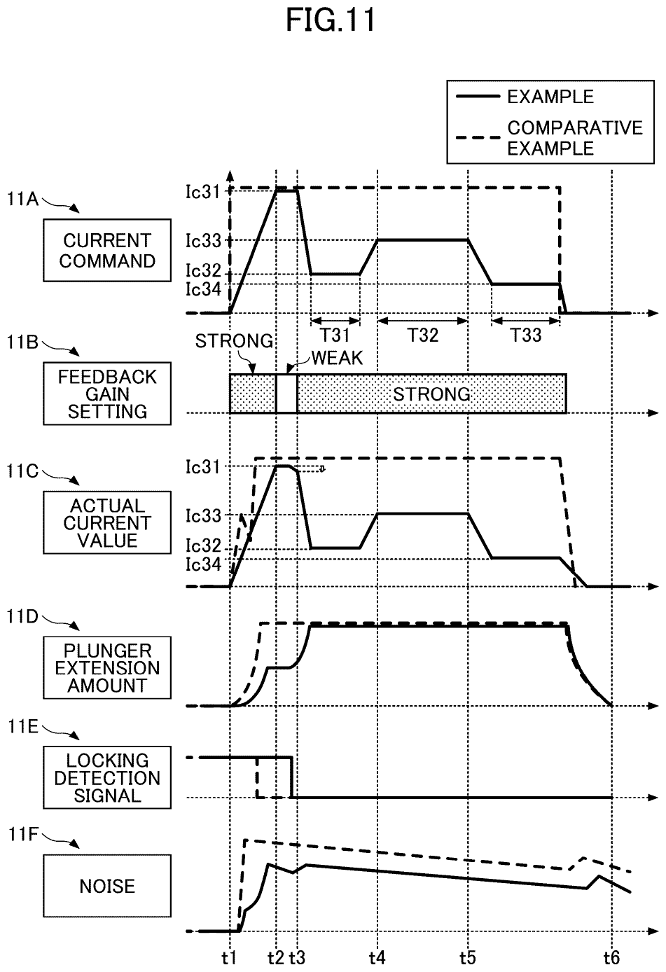

Next, a third example of the control method of the locking device 30 during the unlocking of the door 10 according to the embodiment will be described with reference to FIGS. 11 to 13C.

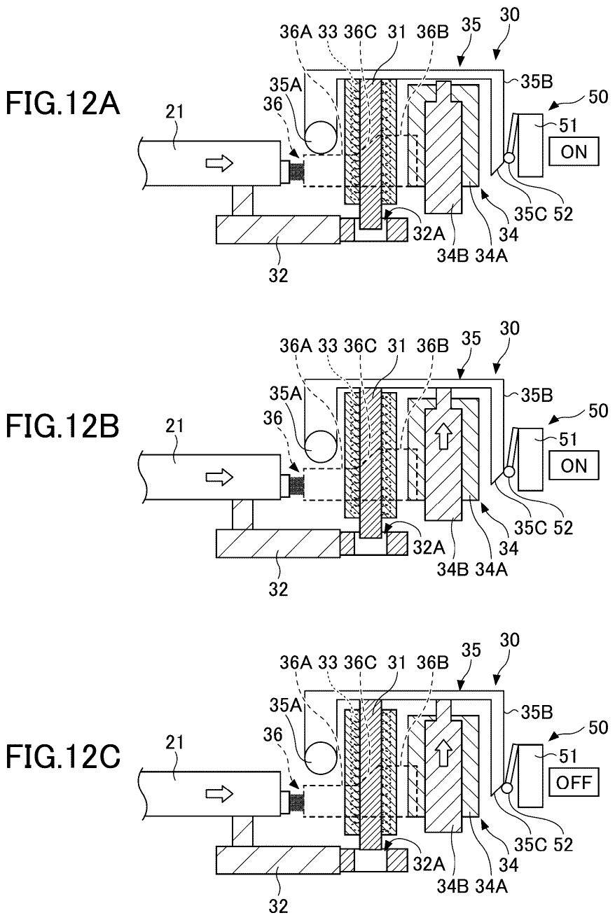

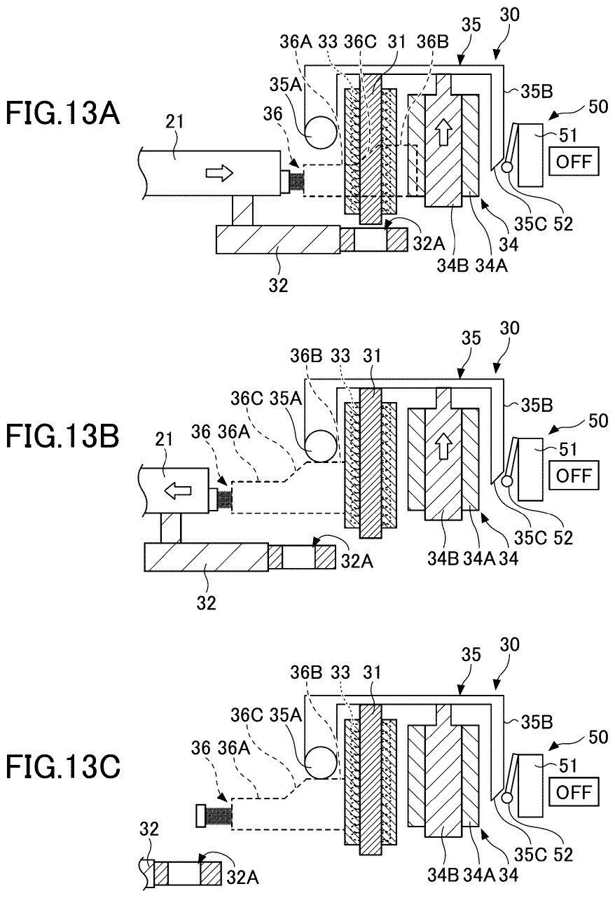

FIG. 11 is a drawing describing the third example of the control method for the locking device 30 during the unlocking of the door 10 by the door controller 80 according to the embodiment. FIGS. 12A to 13C are drawings illustrating an operation of the locking device 30 corresponding to the third example of the control method for the locking device 30 during the unlocking of the door 10.

Specifically, FIG. 11 includes Sections 11A to 11F. Sections 11A and 11B are time charts showing the third example of control method of locking device 30 during unlocking door 10 according to the embodiment, and Sections 11C to 11F are time charts schematically showing the control results by the control method corresponding to Sections 11A and 11B. Section 11A is a time chart showing the third example of time change of current command Ic of coil 34C of solenoid 34 during the unlocking of the door 10. Section 11B is a time chart schematically showing the time change of a feedback gain setting. Section 11C is a time chart schematically showing the time change of the current (actual value) of the coil 34C of the solenoid 34. Section 11D is a time chart schematically showing the time change of the extension amount (plunger extension amount) of the upper end of the plunger 34B of the solenoid 34 from the housing 34A. Section 11E is a time chart schematically showing the time change of the locking detection signal. Section 11F is a time chart schematically showing the time change of the noise amount. FIGS. 12A to 12C show the operation state of the locking 30 device corresponding to each time t1 to t3 of FIG. 11, and FIGS. 13A to 13C show the operation state of the locking device 30 corresponding to each time t4 to t6 of FIG. 11.

The feedback gain is, for example, a proportional gain or an integral gain in PI (Proportional Integral) control. The same may be applied to the control method for the locking device 30 at the time of unlocking the door 10 described later.

As shown in Section 11A in FIG. 11, in this example, at the time t1, the current command Ic of the coil 34C transitions from zero to a predetermined value Ic31 at a relatively gentle constant slope in response to the transition from off to on of the unlocking command signal of the door 10. Then, as shown in Section 11C in FIG. 11, the door controller 80 feedback-regulates so that the current of the coil 34C follows the transition from zero to the predetermined value Ic31 of the current command Ic. Thus, the thrust immediately after the start of the plunger 34B can be reduced more than in the case of the comparative example.

As shown in FIG. 12A, at the time t1, the lock pin 31 is inserted into the lock hole 32A from above, and the actuator 52 of the locking detection switch 50 is pressed against the lateral surface 35B of the vertical slider 35. Therefore, as shown in Section 11E in FIG. 11, at the time t1, the locking detection signal is an on signal.

As shown in Sections 11A and 11C in FIG. 11, at the time t2, the current command Ic reaches the predetermined value Ic31, and accordingly, the current of the coil 34C reaches the predetermined value Ic31.

As shown in Section 11B in FIG. 11, between the time t1 and t2, the door controller 80 sets the feedback gain to a relatively strong state (i.e., a relatively large value). Thus, the door controller 80 can maintain a relatively high followability of the current of the coil 34C to the current command Ic.

As shown in Section 11D in FIG. 11, between the time t1 and time t2, the plunger extension amount rapidly increases according to the transition of the current of the coil 34C, and then increases to a certain level, and then increases very slowly. This is because the biasing force (i.e., elastic force) of the biasing spring 33 increases according to the upward movement of the lock pin 31, and as a result, a difference between the biasing force of the biasing spring 33 and the thrust of the plunger 34B becomes very small. Therefore, as shown in FIG. 12B, at time t2, the plunger extension amount is approximately half of a full stroke. The lower end of the lock pin 31 interlocking with the vertical slider 35 is inserted into the lock hole 32A, and the actuator 52 of the locking detection switch 50 is kept pressed against the lateral surface 35B of the vertical slider 35. Therefore, as shown in Section 11E in FIG. 11, at the time t2, the locking detection signal remains the on signal.

As shown in Section 11A in FIG. 11, when the current command Ic reaches the predetermined value Ic31, it shifts to the state of maintaining the predetermined value Ic31 (time t2). As shown in Section 11B in FIG. 11, at the time t2, the door controller 80 changes the feedback gain from a relatively strong state to a relatively weak state (i.e., a relatively small value). After time t2, the door controller 80 feedback-regulates so as to maintain the current of the coil 34C at the predetermined value Ic31.

As shown in Section 11E in FIG. 11, after the time t2, the plunger extension amount gradually increases, although very slowly, so that the locking detection signal is switched from an on signal to an off signal. As a result, the tip of the actuator 52 of the locking detection switch 50 comes into contact with the lateral surface 35B of the vertical slider 35 to a state where it comes into contact with the lower end surface 35C. As a result, the biasing force acting on the actuator 52 shifts to a state where it acts as a thrust to lift the vertical slider 35 upward. Therefore, a counter electromotive force is generated in the coil 34C of the solenoid 34.

Since the feedback gain is changed to a relatively weak state after the time t2, followability of the current of the coil 34C to the current command Ic decreases. As a result, as shown in Section 11C in FIG. 11, the current decreases due to the counter electromotive force acting on the coil 34C as the locking detection switch 50 shifts from on to off (see a solid-white arrow in the figure).

As shown in Section 11C in FIG. 11, when the decrease in the current of the coil 34C becomes relatively large, the door controller 80 determines that a load state to the plunger 34B has changed (time t3). The relatively large decrease in the current of the coil 34C means, for example, that the current of the coil 34C becomes relatively small relative to a threshold Th1 set at a value slightly below the predetermined value Ic31. The current relatively small relative to the threshold Th1 may mean that the current is smaller than or equal to the threshold Th1, or that the current is smaller than the threshold Th1. The relatively large decrease in the current of the coil 34C on the predetermined value Ic31 may also mean that the value of decrease in the current of the coil 34C becomes relatively large compared to the threshold ΔTh1 (>0). The decrease relatively large relative to the threshold Th1 may mean that the decrease is larger than or equal to the threshold ΔTh1, or that the current is larger the threshold ΔTh1.

As shown in FIG. 12C, at the time t3, the plunger extension amount approaches the full stroke state from the state at time t2, and as described above, the tip of the actuator 52 of the locking detection switch 50 contacts the lower end surface 35C of the vertical slider 35. At the time t3, as described above, although the locking detection signal is an off signal, the lower end of the lock pin 31 is slightly inserted into the lock hole 32A. This is to prevent the door 10 from being determined to be locked when the insertion amount of the lock pin 31 into the lock hole 32A is insufficient from a viewpoint of safety during running of the railway vehicle 1.

As shown in Section 11B in FIG. 11, at the time t3, the door controller 80 changes the setting to return the feedback gain from a relatively weak state to a relatively strong state. As a result, the door controller 80 can return to a state where it can maintain relatively high current followability of the coil 34C to the current command Ic after the time t3.

As shown in Section 11A in FIG. 11, the current command Ic falls from the predetermined value Ic31 to a predetermined value Ic32 (<Ic31) with a relatively steep and constant slope, starting from a timing (time t3) when it is determined that the load state on the plunger 34B has changed. Then, as shown in Section 11C in FIG. 11, the door controller 80 feedback-regulates the current of the coil 34C to follow a downward transition of the current command Ic to the predetermined value Ic32.

As shown in Section 11D in FIG. 11, the plunger extension amount increases with a relatively steep slope, starting from the transition of the lock detection signal from the on signal to the off signal, and reaches the maximum amount (i.e., full stroke) near the timing when the current command Ic reaches the predetermined value Ic32. Thus, the thrust when the plunger 34B reaches the full stroke can be reduced more than in the case of the comparative example.

As shown in Section 11A in FIG. 11, when the current command Ic reaches the predetermined value Ic32, the current command Ic maintains the state of the predetermined value Ic32 for a predetermined duration T31. Then, as shown in Section 11C in FIG. 11, the door controller 80 feedback-regulates to maintain the current of the coil 34C at the predetermined value Ic32 during the predetermined duration T31.

As shown in Section 11A in FIG. 11, the current command Ic transitions upward from the predetermined value Ic32 to a predetermined value Ic33 (Ic32<Ic33<Ic31) with a relatively gentle and constant slope when the predetermined duration T31 for maintaining the state of the predetermined value Ic32 elapses. Then, as shown in Section 11C in FIG. 11, the door controller 80 feedback-regulates the current of the coil 34C to follow the upward transition of the current command Ic from the predetermined value Ic32 to the predetermined value Ic33.

As shown in Section 11A in FIG. 11, when the current command Ic reaches the predetermined value Ic33 (time t4), it maintains the state of the predetermined value Ic33 for the predetermined duration T32. Then, as shown in Section 11C in FIG. 11, the door controller 80 feedback-regulates the current of the coil 34C so as to maintain the current at the predetermined value Ic33 for the predetermined duration T32.

As shown in FIG. 13A, at the time t4, the plunger extension amount is in the maximum state (i.e., full stroke), and the lower end of the lock pin 31 is not inserted into the lock hole 32A at all. In addition, the tip of the actuator 52 of the locking detection switch 50 is separated from the lower end surface of 35C the vertical slider 35, and a constraint by the vertical slider 35 is disengaged.

As shown in Section 11A in FIG. 11, the current command Ic transitions downward from the predetermined value Ic33 to a predetermined value Ic34 (<Ic32) at a relatively gentle constant slope when a predetermined duration T32 for maintaining the state of a predetermined value Ic33 elapses (time t5). Then, as shown in Section 11C in FIG. 11, the door controller 80 feedback-regulates the current of the coil 34C to follow the downward transition of the current command Ic from the predetermined value Ic33 to the predetermined value Ic34.

As shown in FIG. 13B, the opening operation of the door 10 starts between the times t4 and t5, and the opening operation of the door 10 is being executed at the time t5. Therefore, at the time t5, the mover 21, the opening and closing interlocking member 32 including the lock hole 32A, and the horizontal slider 36 are moving in the opening direction, and the abutting part 35A of the vertical slider 35 comes into contact with the supporting surface 36B of the horizontal slider 36.

As shown in Section 11A in FIG. 11, when the current command Ic reaches the predetermined value Ic34, it maintains the state of the predetermined value Ic34 for a predetermined duration T33. Then, as shown in Section 11C in FIG. 11, the door controller 80 feedback-regulates so as to maintain the current of the coil 34C at the predetermined value Ic34 for a predetermined duration T33.

The durations T31, T32 and T33 are set in advance so that, for example, an entire energization time of the coil 34C, starting from the transition of the current command Ic from zero, is sufficiently longer than the minimum time required to complete the unlocking operation by the locking device 30.

As shown in Section 11A in FIG. 11, the current command Ic transitions from the predetermined value Ic34 to zero at a relatively steep and constant slope after a predetermined duration T33 for maintaining the state of the predetermined value Ic34 has elapsed. Then, as shown in Section 11C in FIG. 11, the door controller 80 transitions the current of the coil 34C to zero to follow the downward transition of the current command Ic to zero.

As shown in Section 11D in FIG. 11, the plunger extension amount decreases according to the transition of the current of the coil 34C from the predetermined value Ic34 to zero, and reaches zero after the current of the coil 34C reaches zero (time t6).

As shown in FIGS. 13B and 13C, the horizontal slider 36 follows the opening operation of the door 10 to some extent, but an amount of movement in the opening direction is regulated. Therefore, after time t5, the supporting surface 36B of the horizontal slider 36 can maintain the state of supporting the abutting part 35A of the vertical slider 35. Therefore, as shown in FIG. 13C, at time t6, although the upper end of the plunger 34B is all housed in the housing 34A, the vertical position of the vertical slider 35 is maintained at the position where the lock pin 31 is not inserted into the lock hole 32A.

As shown in Section 11F in FIG. 11, the noise amount of the comparative example takes maximum value between the times t1 and t2 immediately after the start of the movement of the plunger 34B, and thereafter takes a maximum value between time t3 and t4 when the plunger extension amount is maximum. Conversely, in this example, as described above, the thrust immediately after the start of the movement of the plunger 34B and the thrust when the plunger 34B reaches the full stroke can be reduced more than in the comparative example. Therefore, the noise caused by the impact of the start of the movement of the plunger 34B, the noise caused by the impact when the plunger 34B contacts the vertical slider 35, and the noise caused by the impact when the plunger 34B reaches the stroke end are reduced. As a result, the noise amount of the maximum value caused by the sudden increase of the current of the coil 34C and the maximum value caused by the subsequent arrival of the plunger 34B to the stroke end are reduced. Therefore, as in the case of the second example, the door controller 80 can further reduce the noise than in the comparative example.

Moreover, in this example, the door controller 80 determines a change of the load state on the plunger 34B that occurs depending on the vertical position of the lock pin 31, and changes (specifically, decreases) the thrust of the plunger 34B in accordance with the change. Thus, the door controller 80 can change the thrust of the plunger 34B at an appropriate timing in accordance with the vertical position of the lock pin 31. Therefore, the door controller 80 can achieve the noise reduction at the time of unlocking the door 10 by the current control of the coil 34C with relatively high reproducibility.

### Comparative Example of Control Method for Locking Device During Locking of Door

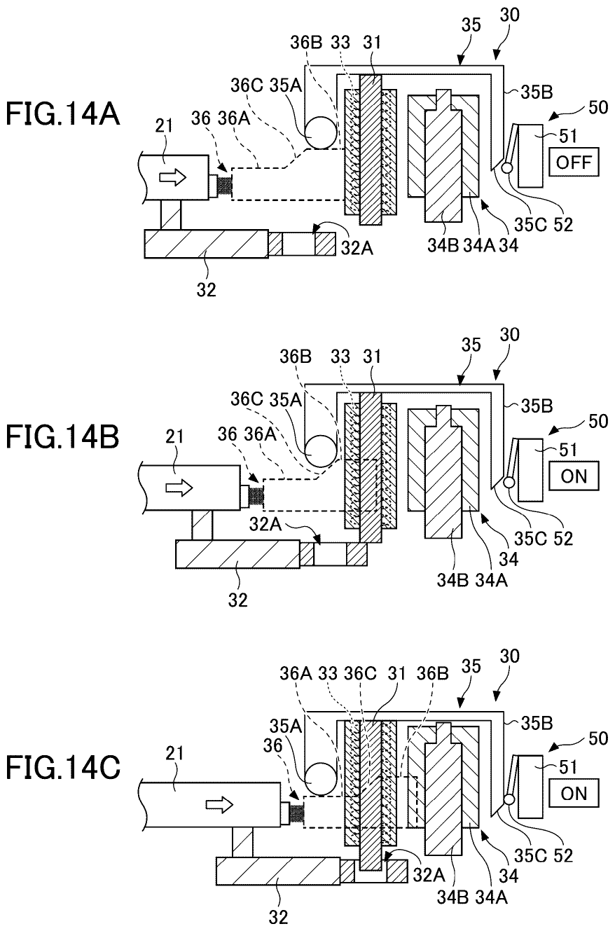

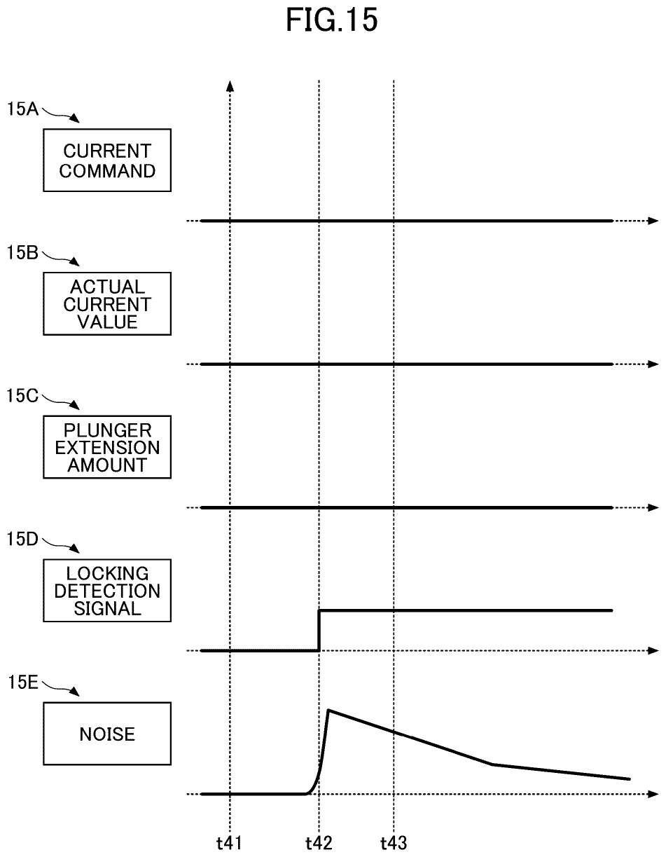

Next, a comparative example of a control method for the locking device 30 while locking the door 10 will be described with reference to FIGS. 14A to 15.

Hereinafter, an executing entity of the control method for the locking device 30 at the time of locking the door 10 will be described as a “door controller” without reference numeral for convenience.

FIGS. 14A to 15 are drawings describing the comparative example of the operation of the locking device 30 while locking the door 10.

Specifically, FIGS. 14A to 14C are drawings schematically showing a time change of an operating state in the comparative example of the operation of the locking device 30 when the door 10 is locked. FIGS. 14A to 14C correspond to the operating states at times t41 to t43 in FIG. 15. FIG. 15 is a time chart showing the state of the solenoid 34 and the locking detection switch 50 and the time change of the noise amount when the door 10 is locked, and includes Sections 15A to 15E. Section 15A is a time chart showing the time change of the current command Ic of the coil 34C of the solenoid 34. Section 15B is a time chart schematically showing the time change of the current (actual value) of the coil 34C of the solenoid 34. Section 15C is a time chart schematically showing the time change of the extension amount (plunger extension amount) of the upper end of the plunger 34B of the solenoid 34 from the housing 34A. Section 15D is a time chart schematically showing the time change of the locking detection signal. Section 15E is a time chart schematically showing the time change of the noise amount.

As shown in FIGS. 14A to 14C and Sections 15A to 15C in FIG. 15, in the comparative example, when the door 10 is locked, the solenoid 34 does not operate.

As shown in FIG. 14A, at time t41, the door 10 is in the closing operation, and the opening and closing interlocking member 32 including the mover 21 and the lock hole 32A moves in the closing direction interlocking with the closing operation of the door 10. The abutting part 35A of the vertical slider 35 is in contact with the supporting surface 36B of the horizontal slider 36, and the lower end of the lock pin 31 is positioned above the upper opening of the lock hole 32A in the vertical direction.

As shown in FIG. 14B, at time t42, the door 10 is still in the closing operation, and the opening and closing interlocking member 32 including the mover 21 and the lock hole 32A moves in the closing direction interlocking with the closing operation of the door 10. The mover 21 can move in the closing direction while pressing the horizontal slider 36, and the horizontal slider 36 moves in the closing direction in accordance with the closing operation of the mover 21. Therefore, the abutting part 35A of the vertical slider 35 changes from the state of abutting on the supporting surface 36B at time t41 to the state of abutting on the supporting surface 36C. As a result, the vertical slider 35 moves downward along the slope of the supporting surface 36C, and the tip of the actuator 52 of the locking detection switch 50 abuts on the lateral surface 35B of the vertical slider 35. Therefore, as shown in FIG. 14B and Section 15D in FIG. 15, the locking detection switch 50 changes from the off state to the on state at time t42.

As shown in FIG. 14C, at a time t43, the lock hole 32A reaches directly below the lock pin 31 due to the movement of the mover 21 and the opening and closing interlocking member in the closing direction interlocking with the closing operation of the door 10. At this time, since the supporting surface 36A is positioned directly below the abutting part 35A of the vertical slider 35, the lock pin 31 can fall downward until the abutting part 35A abuts on the supporting surface 36A. Therefore, the lock pin 31 is inserted so as to fall into the lock hole 32A by the biasing force of the biasing spring 33 and the biasing force by its own weight acting on itself, and the locked state of the door 10 by the locking device 30 can be achieved.

The biasing force of the biasing spring 33 and the biasing force by its own weight act on the lock pin 31. Therefore, as shown in Section 15E in FIG. 15, an extremely large noise may be generated by the impact when the lock pin 31 starts to move when it drops, the impact when the lock pin 31 reaches the stroke end when it drops and the like.

### Control Method for Locking Device During Locking of Door

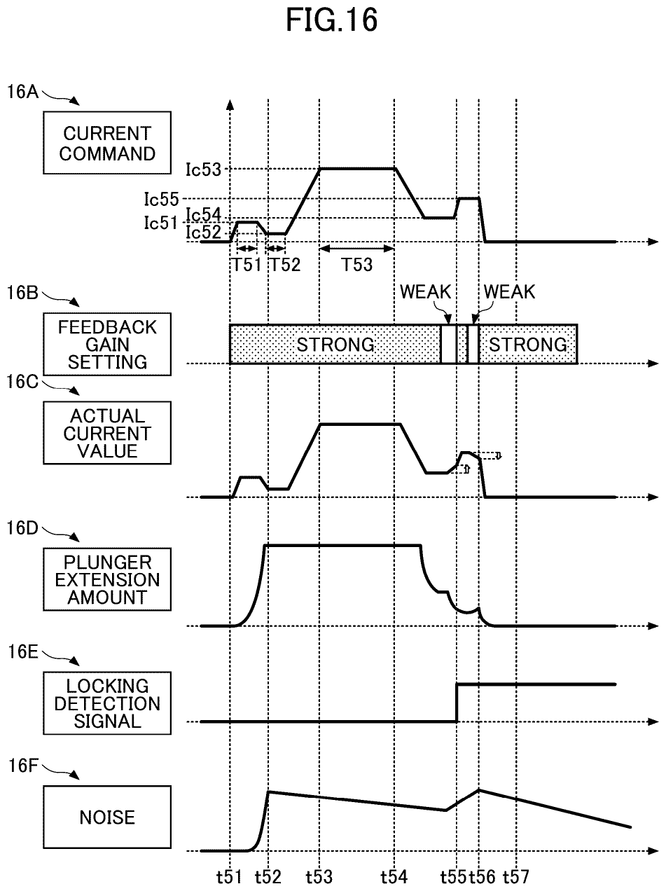

Next, a control method for the locking device 30 while locking the door 10 according to the embodiment will be described with reference to FIGS. 16 to 18C.

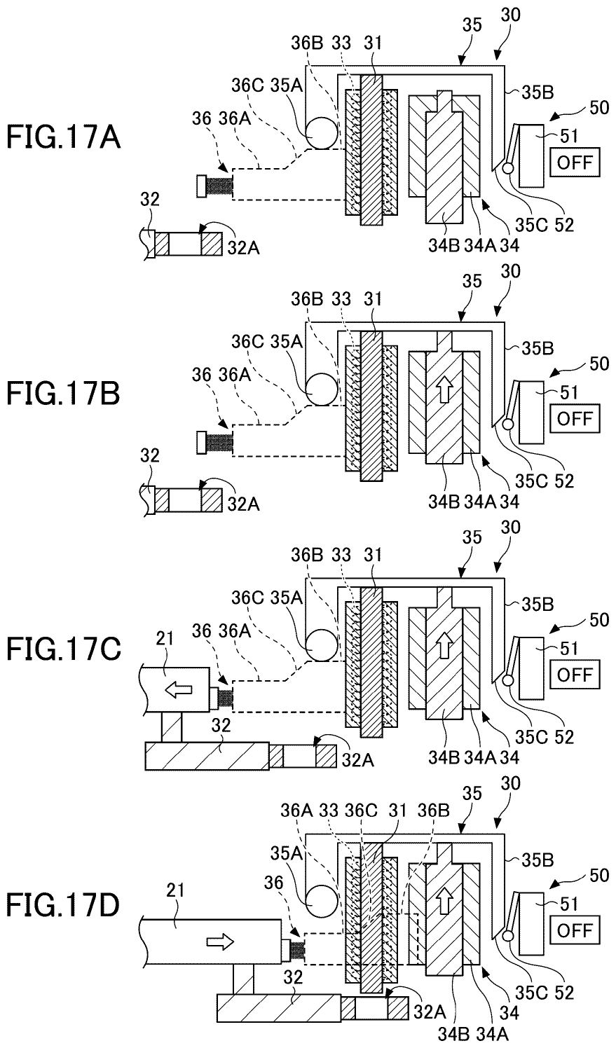

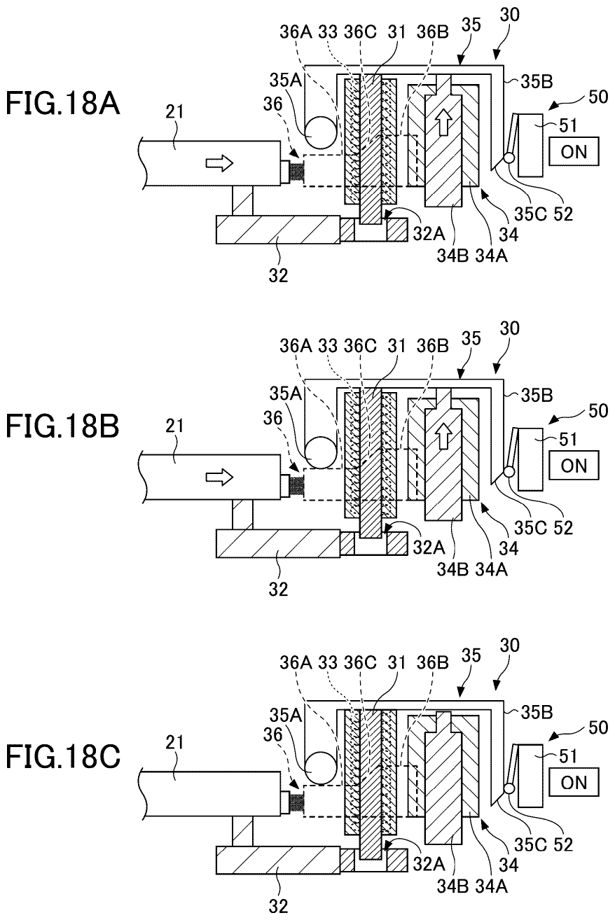

FIG. 16 is a drawing describing an example of the control method for the locking device 30 while locking the door 10 by the door controller 80 according to the embodiment. FIGS. 17A to 18C are drawings illustrating an operation of the locking device 30 corresponding to an example of the control method for the locking device 30 while locking the door 10.

Specifically, FIG. 16 includes Sections 16A to 16F. Sections 16A and 16B are time charts showing an example of the control method for the locking device 30 when the door 10 according to the embodiment is locked, and Sections 16C to 16F are time charts schematically showing the control results by the control method corresponding to Sections 16A and 16B. Section 16A is a time chart showing an example of the time change of the current command Ic of the coil 34C of the solenoid 34 when the door 10 is locked. Section 16B is a time chart schematically showing the time change of the setting of the feedback gain. Section 16C is a time chart schematically showing the time change of the current (actual value) of the coil 34C of the solenoid 34. Section 16D is a time chart schematically showing the time change of the extension amount (plunger extension amount) of the upper end of the plunger 34B of the solenoid 34 from the housing 34A. Section 16E is a time chart schematically showing the time change of the locking detection signal. Section 16F is a time chart schematically showing the time change of the noise amount. FIGS. 17A to 17D show the operation state of the locking device 30 corresponding to each time t51 to t54 of FIG. 16, and FIGS. 18A to 18C show the operation state of locking the device 30 corresponding to each time t55 to t57 of FIG. 16.

As shown in Section 16A in FIG. 16, at a time t51 during the closing operation of the door 10, the current command Ic transitions from zero to a predetermined value Ic51 with a relatively gentle constant slope. Then, as shown in Section 16C in FIG. 16, the door controller 80 feedback-regulates to follow the current of the coil 34C in response to the transition of the current command Ic from zero to the predetermined value Ic51.

The time t51 is predetermined as a timing after the start of the closing operation of the door 10 and sufficiently before the timing (i.e., the timing at which the lock pin 31 can be inserted into the lock hole 32A) when the lock pin 31 and the lock hole 32A are in the same position in the opening and closing directions. For example, the time t51 corresponds to the timing of the start of the closing operation of the door 10. Also, the time t51 may correspond to the timing when the door 10 reaches the predetermined position. In this case, the door controller 80 can determine an arrival of the time t51 based on the output of the encoder 40.

As shown in Section 16B in FIG. 16, at the time of the time t51, the door controller 80 sets the feedback gain to a relatively strong state (i.e., a relatively large value). Thus, the door controller 80 can maintain a relatively high followability of the current of the coil 34C to the current command Ic.

As shown in FIG. 17A, at the time t51, the opening and closing interlocking member 32 including the lock hole 32A is moving in the closing direction interlocking with the closing operation of the door 10, and a large offset exists between the lock hole 32A and the lock pin 31 in the opening and closing directions of the door 10. The abutting part 35A of the vertical slider 35 abuts against the supporting surface 36B of the horizontal slider 36, and the vertical position of the vertical slider 35 is maintained at the position where the lock pin 31 is not inserted into the lock hole 32A. As shown in Section 16D in FIG. 16 and FIG. 17A, the plunger 34B is not in contact with the vertical slider 35, and the upper end of the plunger 34B starts to extend from the housing 34A in response to the start of energization of the coil 34C.

As shown in Section 16A in FIG. 16, when the current command Ic reaches the predetermined value Ic51, it maintains the state of the predetermined value Ic51 for a predetermined duration T51. Then, as shown in Section 16C in FIG. 16, the door controller 80 feedback-regulates to maintain the current of the coil 34C at the predetermined value Ic51.

As shown in Section 16A in FIG. 16, when the predetermined duration T51 for maintaining the predetermined value Ic51 elapses, the current command Ic falls from the predetermined value Ic51 to the predetermined value Ic52 (<Ic51) with a relatively gentle constant slope. Then, as shown in Section 16C in FIG. 16, the door controller 80 feedback-regulates the current of the coil 34C to follow the downward transition of the current command Ic from the predetermined value Ic51 to the predetermined value Ic52.

As shown in Section 16D in FIG. 16, the plunger extension amount increases starting at the time t51 and reaches the full stroke near the timing (time t52) when the plunger extension amount reaches a predetermined value Ic52 due to the downward transition of the current of the coil 34C. Thus, transitioning downward the current of the coil 34C, the door controller 80 can prevent the impact caused by the contact between the plunger 34B and the vertical slider 35 when the plunger extension amount reaches the full stroke.

As shown in FIG. 17B, at the time t52, the opening and closing interlocking member 32 including the lock hole 32A is moving in the closing direction interlocking with the closing operation of the door 10, and a large offset exists between the lock hole 32A and the lock pin 31 in the opening and closing directions of the door 10. Further, the abutting part 35A of the vertical slider 35 abuts on the supporting surface 36B of the horizontal slider 36, and the vertical position of the vertical slider 35 is maintained at the position where the lock pin 31 is not inserted into the lock hole 32A. As shown in Section 16D in FIG. 16 to FIG. 17B, the plunger 34B is in a state where the extension amount from the housing 34A at its upper end is in the full stroke (i.e., maximum), and its upper end abuts on the vertical slider 35.

As shown in Section 16A in FIG. 16, when the current command Ic reaches the predetermined value Ic52, the current command Ic is maintained at the predetermined value Ic52 for a predetermined duration T52. Then, as shown in Section 16C in FIG. 16, the door controller 80 feedback-regulates to maintain the current of the coil 34C at the predetermined value Ic52.

As shown in Section 16A in FIG. 16, the current command Ic transitions upward from the predetermined value Ic52 to a predetermined value Ic53 (>Ic51>Ic52) with a relatively gentle and constant slope when a predetermined duration T52 for maintaining the current at the predetermined value Ic52 elapses. Then, as shown in Section 16C in FIG. 16, the door controller 80 feedback-regulates the current of the coil 34C to follow the transition of the current command Ic from the predetermined value Ic52 to the predetermined value Ic53.

As shown in Section 16C in FIG. 16 and FIG. 17C, at the time t53 when the current of the coil 34C reaches the predetermined value Ic53, the opening and closing interlocking member 32 moves in the closing direction interlocking with the closing operation of the door 10, and shifts to a state of pressing the horizontal slider 36 in the closing direction. Therefore, the horizontal slider 36 moves in the closing direction interlocking with the movement of the opening and closing interlocking member 32 in the closing direction. As a result, at the time t53, although the abutting part 35A of the vertical slider 35 is supported by the supporting surface 36B of the horizontal slider 36, the abutting part 35A of the vertical slider 35 is released from being supported by the supporting surface 36B in accordance with the movement of the horizontal slider 36 in the closing direction. Therefore, by increasing the current of the coil 34C to the predetermined value Ic53 before the abutting part 35A of the vertical slider 35 is released from being supported by the supporting surface 36B, a state in which the vertical slider 35 can be supported from below by only the plunger 34B can be achieved in advance.

As shown in Section 16A in FIG. 16, when the current command Ic reaches the predetermined value Ic53 (time t53), it maintains the predetermined value Ic53 for a predetermined duration T53. Then, as shown in Section 16C in FIG. 16, the door controller 80 feedback-regulates to maintain the current of the coil 34C at the predetermined value Ic53.

As shown in Section 16A in FIG. 16, when the predetermined duration T53 for maintaining the predetermined value Ic53 has elapsed (time t54), the current command Ic falls from the predetermined value Ic53 to the predetermined value Ic54 (Ic51<Ic54<Ic53). Then, as shown in Section 16C in FIG. 16, the door controller 80 feedback-regulates the current of the coil 34C to follow the downward transition of the current command Ic from the predetermined value Ic53 to a predetermined value Ic54.

As shown in FIG. 17D, at a time t54, the lock hole 32A has reached the same position as the lock pin 31 in the opening and closing directions of the door 10 due to the movement of the opening and closing interlocking 32 in the closing member direction of the door 10. That is, the opening and closing interlocking member 32 has reached the position where the lock pin 31 can be inserted into the lock hole 32A. Therefore, at time t54, by reducing the current of the coil 34C, the door controller 80 can achieve a state in which the biasing force of the biasing spring 33, the lock pin 31, and the vertical slider 35 is larger than the thrust of the plunger 34B. As a result, the door controller 80 can start to gently drop the lock pin 31 toward the lock hole 32A.

As shown in Section 16A in FIG. 16, when the current command Ic reaches the predetermined value Ic54, it is maintained at the predetermined value Ic54. Then, the door controller 80 feedback-regulates to maintain the current of the coil 34C at the predetermined value Ic54.

As shown in Section 16B in FIG. 16, when the state in which the current is maintained at the predetermined value Ic54 elapses, the door controller 80 changes the feedback gain from a relatively strong state to a relatively weak state.

As shown in Section 16D in FIG. 16, the plunger extension amount starts to decrease with a relatively large slope as the current of the coil 34C falls to the predetermined value Ic54. Therefore, when the current of the coil 34C is maintained at the predetermined value Ic34, the lock pin 31 and the vertical slider 35 move downward according to the decrease in the plunger extension amount. As a result, the tip of the actuator 52 of the locking detection switch 50 comes into contact with the lower end surface 35C of the vertical slider 35.

When the tip of the actuator 52 of the locking detection switch 50 comes into contact with the lower end surface 35C of the vertical slider 35, the biasing force acting on the actuator 52 acts to push the vertical slider 35 upward. When the plunger extension amount further decreases, the vertical slider 35 moves further downward and changes from the state of contacting the lower end surface 35C of the actuator 52 to the state of contacting the lateral surface 35B. At this time, the biasing force acting on the actuator 52 changes from the state of acting upward on the vertical slider 35 to the state of acting laterally (specifically, the opening direction of the door 10) on the vertical slider 35. Therefore, since the feedback gain is changed to a relatively weak state, the followability to the current command Ic is lowered, and as shown in Section 16C in FIG. 16, the current of the coil 34C increases in accordance with the change of the load state to the plunger 34B (see an upwardly drawn white arrow in the figure).

As shown in Section 16C in FIG. 16, when the increase of the current of the coil 34C becomes relatively large, the door controller 80 determines that the load state to the plunger 34B has changed (time t55). The relatively large increase in the current of the coil 34C means, for example, that the current of the coil 34C becomes relatively large compared to the threshold Th2 set at a value slightly over the predetermined value Ic54. The current relatively large relative to the threshold Th2 may mean that the current is larger than or equal to the threshold Th2, or that the current is larger the threshold Th2. The relatively large increase in the current of the coil 34C may also mean that the value of increase in the current of the coil 34C on the predetermined value Ic54 becomes relatively large compared to the threshold ΔTh2 (>0). The increase relatively large relative to the threshold ΔTh2 may mean that the increase is larger than or equal to the threshold ΔTh2, or larger than the threshold ΔTh2.

As shown in FIG. 18A, at time t55, the lower end of the lock pin 31 has started to be inserted into the lock hole 32A. In addition, as described above, the tip of the actuator 52 of the locking detection switch 50 has shifted from abutting on the lower end surface 35C of the vertical slider 35 to abutting on the lateral surface 35B. Therefore, as shown in Section 16E in FIG. 16, at a time t55, the locking detection signal is switched from the off signal to the on signal.

As shown in Section 16B in FIG. 16, at time t55, the door controller 80 changes the setting to restore the feedback gain from the relatively weak state to the relatively strong state. Thus, the door controller 80 can return to a state in which the followability of the current of the coil 34C to the current IC command after the time t55 can be maintained relatively high.

As shown in Section 16A in FIG. 16, the current command Ic transitions upward from the predetermined value Ic54 to a predetermined value Ic55 (Ic54<Ic55<Ic53) with a relatively steep and constant slope starting from the timing (time t55) when the load state on the plunger 34B is determined to have changed. Then, as shown in Section 16C in FIG. 16, the door controller 80 feedback-regulates the current of the coil 34C to follow the upward transition of the current command Ic to the predetermined value Ic55.

As shown in Section 16A in FIG. 16, when the current command Ic reaches the predetermined value Ic55, the predetermined value Ic55 is maintained. Then, the door controller 80 feedback-regulates to maintain the current of the coil 34C at the predetermined value Ic55.

As shown in Section 16B in FIG. 16, when the state in which the current is maintained at the predetermined value Ic55 elapses, the door controller 80 changes the feedback gain from a relatively strong state to a relatively weak state.

As shown in Section 16D in FIG. 16, when the current of the coil 34C transitions upward to the predetermined value Ic55, the decrease in the plunger extension amount flatlines, and as a result, the downward movement of the lock pin 31 and the vertical slider 35 flatlines. This is because, in addition to the increase in thrust of the solenoid 34, the biasing force of the lock pin 31 decreases due to the decrease in a contraction amount of the biasing spring 33 acting on the lock pin 31.

Here, since the feedback gain is changed to a relatively weak state, the followability to the current command Ic is lowered, and as shown in Section 16C in FIG. 16, the current of the coil 34C decreases in accordance with the change of the load state to the plunger 34B (see the downward solid-white arrow).

As shown in Section 16C in FIG. 16, when the decrease in the current of the coil 34C becomes relatively large, the door controller 80 determines that the load state to the plunger 34B has changed (at a time t56). When the decrease in the current of the coil 34C becomes relatively large, for example, the current of the coil 34C becomes relatively small relative to a threshold value Th3, which is set as a value slightly smaller than the predetermined value Ic55. The state of being relatively small relative to the threshold value Th3 may be a state of being less than or equal to the threshold value Th3, or a state of being smaller than the threshold value Th3. When the decrease in the current of the coil 34C becomes relatively large, the amount of decrease in the current of the coil 34C relative to the predetermined value Ic55 may be relatively large relative to the threshold value ΔTh3 (>0). The state of being relatively large relative to the threshold value ΔTh3 may be a state of being greater than or equal to the threshold value ΔTh3, or a state of being greater than the threshold value ΔTh3.

As shown in FIG. 18B, at the time t56, the vertical position of the lower end of the lock pin 31 has hardly changed since time t55, and the lower end of the lock pin 31 is slightly inserted into the lock hole 32A.

As shown in Section 16B in FIG. 16, at the time t56, the door controller 80 changes the setting to return the feedback gain from a relatively weak state to a relatively strong state. As a result, the door controller 80 can return to a state in which the followability of the current of the coil 34C to the current command Ic after time t56 can be maintained relatively high.

As shown in Section 16A in FIG. 16, the

current command Ic transitions from the predetermined value Ic55 to zero with a relatively steep and constant slope, starting from the timing (time t56) when the load state on the plunger 34B is determined to have changed. Then, as shown in Section 16C in FIG. 16, the door controller 80 feedback-regulates the current of the coil 34C to follow the falling of the current command Ic to zero.

As shown in Section 16D in FIG. 16, the plunger extension amount decreases in accordance with the transition of the current of the coil 34C to zero, and reaches zero after the current of the coil 34C reaches zero.

As shown in FIG. 18C, at a time t57 after the plunger extension amount reaches zero, the abutting part 35A of the vertical slider 35 is supported by the supporting surface 36A of the horizontal slider 36. Thus, the lock pin 31 reaches the lower stroke end, and its lower end is inserted into the lock hole 32A, and the door 10 is completely locked.

As shown in Section 16F in FIG. 16, the noise amount reaches a maximum value at around the time t52 when the plunger 34B comes into contact with the vertical slider 35 and around the time t56 when the current of the coil 34C transitions to zero, and the noise amount reaches a maximum value at around the time t56.

Conversely, in this example, as described above, when the plunger 34B comes into contact with the vertical slider before the lock pin 31 enters the lock hole 32A, the current of the coil 34C falls from the predetermined value Ic51 to the predetermined value Ic52. Therefore, the noise caused by the impact when the plunger 34B comes into contact with the vertical slider 35 can be reduced.

Moreover, in this example, as described above, the plunger 34B supports the vertical slider 35 from below at the timing of starting the downward movement (i.e., fall) of the lock pin 31. Therefore, as shown in Section 16F in FIG. 16, the noise caused by the impact when the lock pin 31 starts moving can be reduced, and as a result, the noise amount at that time does not reach a maximum value.

Moreover, as shown in Section 16D in FIG. 16, in this example, the plunger extension amount is gradually reduced. Therefore, since a drop amount of the lock pin 31 when the plunger extension amount is finally shifted to zero is relatively small, the noise caused by the impact when the lock pin 31 reaches a full stroke can be reduced.

In this example, the door controller 80 determines a change in the load state on the plunger 34B depending on the vertical position of the lock pin 31, and changes the thrust of the plunger 34B according to the change. Thus, the door controller 80 can change the thrust of the plunger 34B at an appropriate timing in accordance with the vertical position of the lock pin 31. Therefore, the door controller 80 can achieve noise reduction at the time of locking the door 10 with relatively high reproducibility by the current control of the coil 34C.

Thus, in this example, the door controller 80 controls the thrust of the solenoid 34 so as to decrease the biasing force of the biasing spring 33 and the lock pin 31 against the lock pin 31 at the time of locking the door 10. Thus, the door controller 80 can reduce noise caused by the locking operation of the locking device 30 at the time of locking the door 10.

### Other Embodiments

Next, other embodiments will be described.

The above-described embodiment may be modified or changed as appropriate.

For example, in the above-described embodiments, other thrust generating devices capable of generating thrust directly or indirectly on the lock pin 31 may be provided instead of the solenoid 34.

In addition, in the above-described embodiment and examples of modifications and changes, the door controller 80 may directly determine the predetermined position of the lock pin 31 instead of determining the change in the load state of the plunger 34B depending on the position of the lock pin 31. Thus, the door controller 80 can directly use the position of the lock pin 31 to increase or decrease the current of the coil 34C at an appropriate timing. In this case, the position of the lock pin 31 may be obtained using a sensor that measures the position of the lock pin 31, or it may be estimated based on the output of the encoder 40, the full closing detection switch 60, or the like.

In the above-described embodiment and examples of modifications and changes, the lock pin 31 is provided on the vehicle body (i.e., fixed part), and the lock hole 32A is provided on the door 10 (i.e., interlocking with the opening and movable part) closing operation of the door 10, but the opposite may be possible.

Further, in the above-described embodiment and examples of modifications and changes, the locking detection switch 50 may be provided not on the side of the vertical slider 35 but below the vertical slider 35, and may be turned on by pressing the actuator 52 from above by the vertical slider 35.

### Operations

Next, the operation of the control apparatus and the control method according to the present embodiment will be described.

In a first aspect of the present embodiment, a controller is configured to control an operation of a locking device, wherein the locking device includes a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door. The controller is, for example, the above-described door controller 80. The railway vehicle is, for example, the above-described railway vehicle 1. The door is, for example, the above-described door 10. The first member is, for example, the above-described opening and closing interlocking member 32 including the lock hole 32A. The second member is, for example, the above-described lock pin 31. The first force is, for example, elastic force of the above-described biasing spring 33 and gravity (self-weight) acting on the lock pin 31. The first force generating part is, for example, the above-described biasing spring 33 generating elastic force and the gravitational force acting on the lock pin 31 itself. The second force generating part is, for example, the above-described solenoid 34. The locking device is, for example, the above-described locking device 30. Specifically, the controller is configured to control the second force generator to reduce the second force during the unlocking of the door.

In a control method according to the first aspect of the present embodiment, the controller is configured to control an operation of a locking device, wherein the locking device includes a first member, a second member configured to achieve a locked state of a door of a railway vehicle by establishing a predetermined positional relation with the first member according to a movement toward the first member, a first force generator configured to generate a first force for moving the second member toward the first member at a time of locking the door, and a second force generator configured to achieve an unlocked state of the door by generating a second force acting against the first force and moving the second member away from the first member at a time of unlocking the door. Specifically, in the control method according to the present embodiment, the controller is configured to control the second force generator to reduce the second force during the unlocking of the door.

Thus, the controller can reduce the second force when the second member reaches the stroke end at the time of unlocking the door, and can reduce noise caused by impact at the time. Therefore, the controller can reduce noise caused by the unlocking operation of the locking device during the unlocking of the door.

In a second aspect of the present embodiment, according to the above-mentioned first aspect, the controller may control the second force generator to shift the second force to a relatively high state from a zero state, and subsequently reduce the second force to a relatively low state during the unlocking of the door.

Thus, the controller can reduce noise caused by the unlocking operation of the locking device during the unlocking of the door, while releasing the state in which the second member has a predetermined positional relation with the first member more quickly.

In a third aspect of the present embodiment, according to the above-mentioned first or second aspect, the controller may control the second force generator to reduce the second force before a switching operation of a switch, wherein the switch is configured to perform the switching operation according to a mechanical interaction with the second member, the switching operation changing the switch from a state of outputting a first signal corresponding to the locked state of the door to a state of outputting a second signal corresponding to the unlocked state of the door. The switch is, for example, the above-mentioned locking detection switch 50. The first signal and the second signal are the above-mentioned on signal and off signal.

Thus, the controller can reduce the second force with certainty when the second member reaches the stroke end and reduce noise caused by impact at that time.

In a fourth aspect of the present embodiment, according to the above-mentioned first or second aspect, the controller may control the second force generator to reduce the second force in accordance with a switching operation of a switch, wherein the switch is configured to perform the switching operation according to a mechanical interaction with the second member, the switching operation changing the switch from a state of outputting a first signal corresponding to the locked state of the door to a state of outputting a second signal corresponding to the unlocked state of the door.

Thus, the controller can reduce the second force with certainty when the second member reaches the stroke end and reduce noise caused by impact at that time while preventing the extension of the time until completion of the unlocking operation of the locking device.

In a fifth aspect of the present embodiment, according to the above-mentioned first or second aspect, the controller may control the second force generator to reduce the second force according to a position of the second member.

Thus, the controller can reduce the second force at the same timing each time in accordance with the position of the second member. Therefore, the controller can improve reproducibility of noise reduction associated with the unlocking operation of the locking device.

In a sixth aspect of the present embodiment, according to the above-mentioned fifth aspect, the controller may control the second force generator to reduce the second force according to a change of a load acting on the second force generator according to a position of the second member.

Thus, the controller can determine the position of the second member from a change in the load acting on the second force generator and decrease the second force at the same timing each time in accordance with the position of the second member. Therefore, the controller can improve reproducibility of noise reduction associated with the unlocking operation of the locking device.

In a seventh aspect of the present embodiment, according to the above-mentioned sixth aspect, the second force generator may be a solenoid. The solenoid is, for example, the solenoid 34 described above. The controller may determine the change of the load acting on the second force generator according to the position of the second member based on a current value of the solenoid, and control the solenoid to reduce the second force.

Thus, the controller may determine a change of the load affecting the solenoid from the current value of the solenoid, and decrease the second force at the same timing with respect to the position of the second member every time.

In an eighth aspect of the present embodiment, according to the above-mentioned seventh aspect, the controller may feedback-regulate, in a first control state, a current of the solenoid to shift the second force to a relatively high state, lower a feedback gain and feedback-regulate the current of the solenoid to maintain a constant current, in a second control state after the first control state, and feedback-regulate the current of the solenoid to reduce the second force to a relatively low state when the current of the solenoid deviates by more than a predetermined range during the second control state.

Thus, the controller can determine a change of the load affecting the solenoid from the current value of the solenoid with certainty, and decrease the thrust at the same timing with respect to the position of the second member every time.

In a ninth aspect of the present embodiment, a controller is configured to control an operation of a locking device including a first member, a second member configured to achieve a locked state of a door of a railway vehicle by establishing a predetermined positional relation with the first member according to a movement toward the first member, a first force generator configured to generate a first force for moving the second member toward the first member during locking the door, and a second force generator configured to achieve an unlocked state of the door by generating a second force acting against the first force and moving the second member away from the first member at a time of unlocking the door. Specifically, the controller is configured to control the second force generator to generate the second force to reduce an effect of the first force generator on the second member.

In a control method according to the ninth aspect of the present embodiment, the controller is configured to control an operation of a locking device including a first member, a second member configured to achieve a locked state of a door of a railway vehicle by establishing a predetermined positional relation with the first member according to a movement toward the first member, a first force generator configured to generate a first force for moving the second member toward the first member during locking the door, and a second force generator configured to achieve an unlocked state of the door by generating a second force acting against the first force and moving the second member away from the first member at a time of unlocking the door. Specifically, in the control method according to the present embodiment, the controller is configured to control the second force generator to generate the second force to reduce an effect of the first force generator on the second

Thus, the controller can reduce the impact when the second member starts moving due to the first force and when the second member reaches the stroke end when the door is locked. Therefore, the controller can reduce the noise caused by the unlocking operation of the locking device when the door is locked.

In a tenth aspect of the present embodiment, the controller may control the second force generator to generate the second force that is relatively high before the second member becomes in a state capable of moving to establish the predetermined positional relation with the first member, and shift a state of the second force generator to a state to generate the second force that is relatively low, when the second force generator becomes the state capable of moving to establish the predetermined positional relation with the first member during a closing operation of the door.

Thus, when the second member can move so as to establish the predetermined positional relation with the first member in response to the closing operation of the door, the controller can prevent the sudden start of movement of the second member due to the first force and reduce the noise caused by the impact when the second member starts moving.

In an eleventh aspect of the present embodiment, at a time of starting the closing operation of the door, a working part configured to apply the second force to the second member in the second force generator is not required to be in a position where the second force can be applied to the second member. The working part may be, for example, a plunger 34B. During the closing operation of the door, the controller may control the second force generator, and move to a position where the working part can apply the second force to the second member before the second member becomes in the state capable of moving to establish the predetermined positional relation with the first member.

Thus, when the second member can be moved so as to establish the predetermined positional relation with the first member, the controller can apply the second force to the second member so as to reduce noise caused by impact when the second member starts moving.

In aspect of the present a twelfth embodiment, the controller may control the second force generator to reduce the second force in accordance with a switching operation of a switch, is configured to perform the wherein the switch switching operation according to a mechanical interaction with the second member, the switching operation changing the switch from state of outputting a first signal corresponding to the locked state of the door to a state of outputting a second signal corresponding to the unlocked state of the door.

Thus, the controller can reduce the impact when the second member reaches the stroke end while preventing the extension of the time until completion of the locking operation of the locking device, and can reduce the noise at that time.

In a thirteenth aspect of the present embodiment, the controller may control the second force generator to enhance the second force according to a position of the second member.

Thus, the controller can enhance the thrust at the same timing each time according to the position of the second member, and can reduce the noise caused by the impact when the second member reaches the stroke end with certainty. Therefore, the controller can improve the reproducibility of noise reduction associated with the locking operation of the locking device.

In a fourteenth aspect of the present embodiment, the controller may control the second force generator to enhance the second force according to a change of a load affecting the second force generator according to the position of the second member.

Thus, the controller can determine the position of the second member from the change of the load affecting the second force generator, and can enhance the second force at the same timing each time with respect to the position of the second member. Therefore, the controller can improve the reproducibility of noise reduction associated with the locking operation of the locking device.

In a fifteenth aspect of the present embodiment, the second force generator may be a solenoid. The controller may determine the change of the load acting on the second force generator according to the position of the second member based on a current value of the solenoid, and control the solenoid to reduce the second force.

Thus, the controller may determine a change of the load affecting the solenoid from the current value of the solenoid, and enhance the thrust at the same timing each time with respect to the position of the second member.

In a sixteenth aspect of the present embodiment, the controller may feedback-regulate, in a first control state, a current of the solenoid to shift the second force from a relatively high state to a relatively low state when the second member becomes in the state capable of moving to establish the predetermined positional relation with the first member, lower a feedback gain and feedback-regulate the current of the solenoid to maintain a constant current, in a second control state after the first control state, and feedback-regulate the current of the solenoid to enhance the second force when the current of the solenoid deviates by more than a predetermined range during the second control state.

Thus, the controller can determine a change of the load affecting the solenoid from the current value of the solenoid with certainty, and enhance the second force at the same timing each time with respect to the position of the second member.

Further, the present invention is not limited to these embodiments, and various changes and modifications may be made without departing from the scope of the present invention.

What is claimed is:

1. A controller for controlling an operation of a locking device,
wherein the locking device comprises:
a first member;
a second member configured to achieve a locked state of a door of a railway vehicle by establishing a predetermined positional relation with the first member according to a movement toward the first member;
a first force generator configured to generate a first force for moving the second member toward the first member at a time of locking the door; and
a second force generator configured to achieve an unlocked state of the door by generating a second force acting against the first force and moving the second member away from the first member at a time of unlocking the door, and
wherein the controller is configured to control the second force generator to reduce the second force during the unlocking of the door.

2. The controller according to claim 1, wherein the controller is configured to control the second force generator to shift the second force to a relatively high state from a zero state, and subsequently reduce the second force to a relatively low state during the unlocking of the door.

3. The controller according to claim 1, wherein the controller is configured to control the second force generator to reduce the second force before a switching operation of a switch, wherein the switch is configured to perform the switching operation according to a mechanical interaction with the second member, the switching operation changing the switch from a state of outputting a first signal corresponding to the locked state of the door to a state of outputting a second signal corresponding to the unlocked state of the door.

4. The controller according to claim 1, wherein the controller is configured to control the second force generator to reduce the second force in accordance with a switching operation of a switch, wherein the switch is configured to perform the switching operation according to a mechanical interaction with second member, the switching operation changing the switch from a state of outputting a first signal corresponding to the locked state of the door to a state of outputting a second signal corresponding to the unlocked state of the door.

5. The controller according to claim 1, wherein the controller is configured to control the second force generator to reduce the second force according to a position of the second member.

6. The controller according to claim wherein the controller is configured to control the second force generator to reduce the second force according to a change of a load acting on the second force generator according to a position of the second

7. The controller according to claim 6,
wherein the second force generator is a solenoid, and
is configured to determine the change of the load acting on the solenoid according to the position of the second member based on a current value of the solenoid, and control the solenoid to reduce the second force.

8. The controller according to claim 7, wherein the controller is configured to:
feedback-regulate, in a first control state, a current of the solenoid to shift the second force to a relatively high state;
lower a feedback gain and feedback-regulate the current of the solenoid to maintain a constant current, in a second control state after the first control state; and
feedback-regulate the current of the solenoid to reduce the second force to a relatively low state when the current of the solenoid deviates by more than a predetermined range during the second control state.

9. A controller for controlling an operation of a locking device,
wherein the locking device comprises:
a first member;
a second member configured to achieve a locked state of a door of a railway vehicle by establishing a predetermined positional relation with the first member according to a movement toward the first member;
a first force generator configured to generate a first force for moving the second member toward the first member at a time of locking the door; and
a second force generator configured to achieve an unlocked state of the door by generating a second force acting against the first force and moving the second member away from the first member at a time of unlocking the door, and
wherein the controller is configured to control the second force generator to generate the second force to reduce an effect of the first force generator on the second member.

10. The controller according to claim 9, wherein the controller is configured to control the second force generator to generate the second force that is relatively high before the second member becomes in a state capable of moving to establish the predetermined positional relation with the first member, and shift a state of the second force generator to a state to generate the second force that is relatively low, when the second member becomes in the state capable of moving to establish the predetermined positional relation with the first member during a closing operation of the door.

11. The controller r according to claim 10, wherein at a time of starting the closing operation of the door, a working part configured to apply the second force to the second member in the second force generator is not in a position where the second force can be applied to the second member, and
wherein during the closing operation of the door, the controller is configured to control the second force generator, and move the working part to a position where the working part can apply the second force to the second member before the second member becomes the state capable of moving to establish the predetermined positional relation with the first member.

12. The controller according to claim 9, wherein the controller is configured to control the second force generator to reduce the second force in accordance with a switching operation of a switch, wherein the switch is configured to perform the switching operation according to a mechanical interaction with the second member, the switching operation changing the switch from a state of outputting a first signal corresponding to the locked state of the door to a state of outputting a second signal corresponding to the unlocked state of the door.

13. The controller according to claim 9, wherein the controller is configured to control the second force generator to increase the second force according to a position of the second member.

14. The controller according to claim 13, wherein the controller is configured to control the second force generator to increase the second force according to a change of a load acting on the second force generator according to the position of the second member.

15. The controller according to claim 14,
wherein the second force generator is a solenoid, and
wherein the controller is configured to determine the change of the load acting on the solenoid according to the position of the second member based on a current value of the solenoid, and control the solenoid to reduce the second force.

16. The controller according to claim 15, wherein the controller is configured to:
feedback-regulate, in a first control state, a current of the solenoid to shift the second force from a relatively high state to a relatively low state when the second member becomes in the state capable of moving to establish the predetermined positional relation with the first member;
lower a feedback gain and feedback-regulate the current of the solenoid to maintain a constant current, in a second control state after the first control state; and
feedback-regulate the current of the solenoid to increase the second force when the current of the solenoid deviates by more than a predetermined range during the second control state.

17. A control method for controlling an operation of a locking device, the locking device including:
a first member;
a second member configured to achieve a locked state of a door of a railway vehicle by establishing a predetermined positional relation with the first member according to a movement toward the first member;
a first force generator configured to generate a first force for moving the second member toward the first member at a time of locking the door; and
a second force generator configured to achieve an unlocked state of the door by generating a second force acting against the first force and moving the second member away from the first member at a time of unlocking the door,
wherein the control method comprises controlling the second force generator to reduce the second force during the unlocking of the door.

18. A control method for controlling an operation of a locking device, the locking device including:
a first member;
a second member configured to achieve a locked state of a door of a railway vehicle by establishing a predetermined positional relation with the first member according to a movement toward the first member;
a first force generator configured to generate a first force for moving the second member toward the first member at a time of locking the door; and
a second force generator configured to achieve an unlocked state of the door by generating a second force acting against the first force and moving the second member away from the first member at a time of unlocking the door,
wherein the control method comprises controlling the second force generator to generate the second force to reduce an effect of the first force generator on the second member during the unlocking of the door.
